(19) United States
(12) Patent Application Publication
(10) Pub. No.: US 2004/0033475 A1
(43) Pub. Date: Feb. 19, 2004

(54) Method and system for monitoring and managing the educational progess of students

(76) Inventors: Yoshi Mizuma, Fort Lee, NJ (US); Cheryl Chin, Edison, NJ (US); George Oshita, Fort Lee, NJ (US); ViJay Nair, Dayton, NJ (US); Stephanie Pagan, Cliffside Park, NJ (US); Hiroaki Nihongi, Tenafly, NJ (US); Lisa Kaul, Hoboken, NJ (US); Hideki Kusuzawa, Gifu City (JP)

Correspondence Address: WILEY, REIN & FIELDING, LLP, ATTN: PATENT ADMINISTRATION, 1776 K. STREET N.W., WASHINGTON, DC, 20006, US

(21) Appl. No.: 10/422,781

(22) Filed: Apr. 25, 2003

Related U.S. Application Data
(60) Provisional application No. 60/375,420, filed on Apr. 26, 2002.

(51) Int. Cl. G09B 7/00; G06F 17/60

(52) U.S. Cl. 434/219; 434/322; 705/14

(57) ABSTRACT

The present invention relates generally to educational systems, and may include methods of using a computer system to create student records in a database; methods of using a computer system to present student records stored in a computer database; methods for measuring a student's performance relative to predetermined educational goals; automated processes that utilize a relational database for student education; automated education management systems; and computer programs for automating an education system. In one particular embodiment, the present invention relates a computerized method for measuring a student's educational performance comprising: accessing data on a student record database; accessing data on a progress goals database; accessing data on a study plan database; accepting student progress data such as completed assignments and test results; generating a progress report; modifying at least one of the data relating to a student record, the data relating to the predetermined set of progress goals, and the data relating to a predetermined study plan; and storing the data relating to a student record, the data relating to a predetermined set of progress goals, the data relating to a predetermined study plan, and the student progress data, all in the computer database.

### RELATED APPLICATIONS

This application claims priority to U.S. Provisional Application No. 60/375,420, filed Apr. 26, 2002, which is incorporated by reference in its entirety.

### FIELD OF THE INVENTION

The present invention pertains generally to the educational instruction field, and more particularly, to the methods and systems for monitoring and managing the education progress of students.

### BACKGROUND OF THE INVENTION

A new and improved way to monitor and manage the education progress of students is needed. Instructors often find themselves over burdened with the usual processes of planning teaching lessons, teaching classes, and grading tests. A new and improved way to provide individualized attention to students is needed, so that each student can learn at a pace that is optimum for the individual student's needs and abilities.

### SUMMARY OF THE INVENTION

Disclosed herein is an automated end-to-end business process for education that uses a relational computer database management system, the process comprising the steps of: requesting an instructor to input diagnostic test data for a student into a student record in a computer database; generating a set of progress goals for the student using the student record, the set of progress goals comprising one or more study levels, each study level comprising a plurality of assignments, assignment data for each of the one or more study levels, and an estimated timeframe for completing the plurality of assignments for each of the one or more study levels; generating a study plan for the student, the study plan comprising a student schedule; requesting an instructor to input student progress data for the student, the student progress data comprising completed assignment data and test results; generating a progress report for the student, the progress report comprising the student progress data and any deviations from the study plan; and storing the student progress data, the student record, the set of progress goals, and the study plan in the relational computer database management system. The step of generating a study plan may further comprise: selecting a predetermined repetition plan that repeats at least a portion of the plurality of assignments for one or more study levels; and automatically revising the student schedule to incorporate the predetermined repetition plan. The process may further comprise: automatically generating an instructor alert report, the instructor alert report identifying a student whose performance has dropped below a predetermined threshold and identifying areas that require instructor attention for the student; requesting an instructor to input adjustments to the study plan for the identified student; and storing the student progress data, the student record, the set of progress goals, and the adjusted study plan in the relational computer database management system. The step of requesting an instructor to input adjustments to the study plan may further comprise requesting an instructor to input adjustments to a study plan of a student based on the progress report or the instructor alert report for the student. The process also may further comprise generating a group report comprising student progress data for a plurality of students. The process may further comprise: including in the student progress report a comparison of the student progress data to the set of progress goals for the student; requesting an instructor to input adjustments to the progress report for a student based on a review of the comparison; and automatically updating the study plan for the student based on changes input to the progress report. The step of generating a set of progress goals may further comprise: generating a set of progress goals for the student using one of a plurality of predefined progress goal templates stored on the relational computer database management system; modifying the set of progress goals; and storing the modified set of progress goals as at least one of a progress goals template and a set of progress goals for the student. The step of generating a study plan may further comprise: generating a study plan for the student using one of a plurality of predefined study plan templates stored on the relational computer database management system; modifying the study plan; and storing the modified study plan as at least one of a study plan template and a study plan for the student. The process may further comprise generating a report that compares a student's actual performance, as measured by student progress data, with expected progress, as measured by a set of progress goals.

Also disclosed herein is a method of using a computer system to create a plurality of student records to be stored in a computer database, the method comprising: presenting a plurality of functional menus to an instructor on a computer terminal, the plurality of menus including a new student record creation menu, a progress goals creation menu, and a study plan creation menu; requesting, in response to the new student record creation menu being selected, an instructor to input historical student data for a student, the historical student data comprising diagnostic test data for said student; creating a student record in a computer database for the student; storing the historical student data for the student to the student record in the computer database; assembling, in response to the progress goal creation menu being selected, a set of progress goals for the student, the set of progress goals comprising one or more study levels, a plurality of assignments for each of the one or more study levels, and an estimated timeframe for completing the plurality of assignments for each of the one or more study levels; automatically assembling, in response to a study plan creation menu being selected, a study plan for the student, the study plan comprising a student schedule; and storing the set of progress goals and the study plan to the student record in the computer database. The set of progress goals may further comprise a repetition plan for repeating at least a portion of the plurality of assignments for one or more study levels. The step of assembling a set of progress goals may further comprise assembling a set of progress goals for the student in response to the selection of a progress goal template from the computer database. The step of assembling a set of progress goals also may further comprise: accepting input from an instructor to permit the set of progress goals for the student to be modified in accordance with said input; and storing the modified set of progress goals in the student record in the computer database. The step of assembling a study plan may further comprise assembling a study plan for the student in response to the selection of a study plan template from the computer database. The step of assembling a study plan also may further comprise: accepting input from an instructor to permit the study plan for the student to be modified in accordance with said input; and storing the modified study plan in the student record in the computer database.

Also disclosed herein is a method of using a computer system to present information pertaining to a plurality of student records stored in a computer database, each of said plurality of student records comprising a student identifier and diagnostic test data for the selected one of the plurality of students, the method comprising: presenting a plurality of menus to an instructor on a computer terminal, the plurality of menus comprising a student record menu, a study plan menu, a progress goals menu, and a progress report menu; displaying on the computer terminal a selector to permit an instructor to select one or more of the plurality of menus; accepting input through the selector, which input indicates the selection of the student record menu, said student record menu permitting an instructor to select at least one of the plurality of student records using the student identifier; displaying the selected student record; accepting student progress data for the student whose student record has been selected, the student progress data comprising completed assignment data and test results in accordance with a predetermined student schedule; and assembling a progress report for the student using the student progress data. The method may further comprise: accepting adjustments to the study plan for the selected student; and automatically updating the progress report based on adjustments to the study plan. The method also may further comprise: displaying on the computer terminal a set of progress goals corresponding to a selected student record; accepting modifications to the set of progress goals; and storing the modified set of progress goals in the computer database. The method also may further comprise: displaying on the computer terminal a study plan corresponding to a selected student record; accepting modifications to the study plan; and storing the modified study plan in the computer database. The method also may further comprise: automatically assembling an instructor alert report for a student whose performance has dropped below a predetermined threshold, which instructor alert report identifies areas requiring instructor attention for the student; and automatically displaying the instructor alert report on the computer terminal.

Also disclosed herein is a method for measuring the educational performance of a student relative to predetermined educational goals comprising: accessing data on a computer database relating to a student record; accessing data on a computer database relating to a predetermined set of progress goals associated with a student; accessing data on a computer database relating to a predetermined study plan associated with the student; accepting student progress data, the student progress data comprising completed assignment data and test results in accordance with a predetermined student schedule; generating a student progress report based on at least one of the data relating to a student record, the data relating to the predetermined set of progress goals, the data relating to a predetermined study plan, and the student progress data; modifying at least one of the data relating to a student record, the data relating to the predetermined set of progress goals, and the data relating to a predetermined study plan; and storing the data relating to a student record, the data relating to a predetermined set of progress goals, the data relating to a predetermined study plan, and the student progress data, all in the computer database. The method may further comprise: providing an instructor alerts database, the instructor alert database comprising a plurality of instructor alert conditions; automatically generating an instructor alert report for a student whose progress data indicates that the student's performance matches one or more of the instructor alert conditions contained in the instructor alerts database; modifying at least one of the data relating to a student record, the data relating to the predetermined set of progress goals, the data relating to a predetermined study plan, and the student progress data; automatically updating the data relating to the student record, the data relating to the predetermined set of progress goals, and the data relating to a predetermined study plan; and storing in the computer database the updated data relating to the student record, the updated data relating to the predetermined set of progress goals, the updated data relating to a predetermined study plan, and the updated student progress data.

Also disclosed herein is an automated education management system, the system comprising: an menu module, that presents a plurality of menus to an instructor on a computer terminal, the plurality of menus comprising a student record menu, a study plan menu, a progress goals menu, and a progress report menu; a data entry module that permits the instructor using an input device to enter diagnostic test data and student progress data for a plurality of students, the student progress data comprising completed assignment data and test results in accordance with a student schedule for each of the plurality of students; a storage module that stores, at least, the diagnostic test data and the student progress data so that one or more of the diagnostic test data and the student progress data can be presented when one or more of the plurality of menus is accessed by the instructor; one or more template modules, associated with the plurality of menus, the one or more template modules comprising at least one of a student record template module, a set of progress goals template module, a study plan template module, and a progress report template module; a selection module for enabling an instructor to select one or more menus and one or more modules using an input device; and an assembly module that assembles a student record comprising a set of progress goals, a study plan, and a progress report using the one or more template modules and the one or more of the plurality of menus, the set of progress goals comprising one or more study levels, a plurality of assignments for each of the one or more study levels, and an estimated timeframe for completing the plurality of assignments for each of the one or more study levels, the study plan comprising a student schedule, and the progress report comprising the student progress data and any deviations from the study plan. The system optionally may exist as a computer program on a computer readable medium. The system may further comprise an instructor preparation module for determining which students are scheduled to attend a particular class session, what consumable educational materials are required for the particular class session, and which, if any, students do not have predetermined assignments for the particular class session. The system may further comprise: a progress monitoring module that automatically compares the progress report with a predetermined set of instructor alert conditions and automatically generates an instructor alert report for a student whose progress data indicates that the student's performance matches one or more of the instructor alert conditions, indicating the student's performance has dropped below a predetermined threshold; and an alert presentation module that automatically displays an instructor alert report to the instructor on the computer terminal. The one or more template modules may further comprises a repetition plan template module, the repetition plan template module comprising a predetermined repetition plan for repeating at least a portion of the plurality of assignments for one or more study levels; and the assembly module may assemble the student record comprising a set of progress goals, a study plan, and a progress report using the repetition plan template module and the one or more of the plurality of menus. The system may further comprise a batch assembly module that automatically assembles the student record comprising a set of progress goals, a study plan, and a progress report for each of a plurality of students using the one or more template modules and the one or more of the plurality of menus. The system may further comprise a template creation module that stores at least one of a student record to a student record template module, an instructor created set of progress goals to a set of progress goals template module, an instructor created study plan to a study plan template module, and an instructor created progress report to a progress report template module. The system may further comprise: an inventory prediction module for estimating a quantity of consumable educational materials to be used in a predetermined time period, said quantity of consumable educational materials being estimated using at least one of (1) a quantity of consumable educational materials used in a preceding time period and (2) a quantity of consumable educational materials projected for the predetermined time period based on the study plan for each of a plurality of students; and an inventory management module for tracking the use of consumable educational materials and generating an order for additional consumable educational materials based on the estimated quantity of educational materials to be used in a predetermined time period. The system may further comprise: a financial management module for generating tuition bills based on student data stored in the storage module and tracking tuition payments. The financial management module may (1) compare a quantity of consumable educational materials used in a preceding time period with an expected quantity of consumable educational materials used based on the student progress data stored in the storage module and (2) generate a disparity report if the difference between the quantity used and the expected quantity used exceeds a predetermined threshold.

Further disclosed herein is a computer program embodied in a computer readable medium for automating an education system, the program comprising: an menu module, that presents a plurality of menus to an instructor on a computer terminal, the plurality of menus comprising a student record menu, a study plan menu, a progress goals menu, and a progress report menu; a data entry module that permits the instructor using an input device to enter diagnostic test data and student progress data for a plurality of students, the student progress data comprising completed assignment data and test results in accordance with a student schedule for each of the plurality of students; a storage module that stores, at least, the diagnostic test data and the student progress data so that one or more of the diagnostic test data and the student progress data can be presented when one or more of the plurality of menus is accessed by the instructor; one or more template modules, associated with the plurality of menus, the one or more template modules comprising at least one of a student record template module, a set of progress goals template module, a study plan template module, and a progress report template module; a selection module for enabling an instructor to select one or more menus and one or more modules using an input device; and an assembly module that assembles a student record comprising a set of progress goals, a study plan, and a progress report using the one or more template modules and the one or more of the plurality of menus, the set of progress goals comprising one or more study levels, a plurality of assignments for each of the one or more study levels, and an estimated timeframe for completing the plurality of assignments for each of the one or more study levels, the study plan comprising a student schedule, and the progress report comprising the student progress data and any deviations from the study plan. The program may further comprise an instructor preparation module for determining which students are scheduled to attend a particular class session, what consumable educational materials are required for the particular class session, and which, if any, students do not have predetermined assignments for the particular class session. The program may further comprise: a progress monitoring module that automatically compares the progress report with a predetermined set of instructor alert conditions and automatically generates an instructor alert report for a student whose progress data indicates that the student's performance matches one or more of the instructor alert conditions, indicating the student's performance has dropped below a predetermined threshold; and an alert presentation module that automatically displays an instructor alert report to the instructor on the computer terminal. The one or more template modules may further comprise a repetition plan template module, the repetition plan template module comprising a predetermined repetition plan for repeating at least a portion of the plurality of assignments for one or more study levels; and the assembly module may assemble the student record comprising a set of progress goals, a study plan, and a progress report using the repetition plan template module and the one or more of the plurality of menus. The program may further comprise a batch assembly module that automatically assembles the student record comprising a set of progress goals, a study plan, and a progress report for each of a plurality of students using the one or more template modules and the one or more of the plurality of menus. The program may further comprise a template creation module that stores at least one of a student record to a student record template module, an instructor created set of progress goals to a set of progress goals template module, an instructor created study plan to a study plan template module, and an instructor created progress report to a progress report template module. The program may further comprise: an inventory prediction module for estimating a quantity of consumable educational materials to be used in a predetermined time period, said quantity of consumable educational materials being estimated using at least one of (1) a quantity of consumable educational materials used in a preceding time period and (2) a quantity of consumable educational materials projected for the predetermined time period based on the study plan for each of a plurality of students; and an inventory management module for tracking the use of consumable educational materials and generating an order for additional consumable educational materials based on the estimated quantity of educational materials to be used in a predetermined time period. The program may further comprise: a financial management module for generating tuition bills based on student data stored in the storage module and tracking tuition payments. The financial management module may (1) compare a quantity of consumable educational materials used in a preceding time period with an expected quantity of consumable educational materials used based on the student progress data stored in the storage module and (2) generate a disparity report if the difference between the quantity used and the expected quantity used exceeds a predetermined threshold.

### BRIEF DESCRIPTION OF THE DRAWINGS

FIG. 1 represents a block diagram of one embodiment of the present invention. FIG. 1 shows five major functional groups: administration, class management, accounting, purchasing, and inventory management.

FIG. 2 represents a block diagram of the administration and class management functions performed by the present invention.

FIG. 3 represents a block diagram of the tuition collection database, which is a part of the financial management module of the present invention.

FIG. 4 represents a block diagram of the inventory management module of the present invention.

FIGS. 5A and 5B represent a block diagram of the instructor preparation module of the present invention.

FIG. 6 represents the implementation and use of progress goal breakdown charts and graphs as part of the integrated educational system of the present invention.

FIGS. 7-29 are screen prints showing the functionality of the features discussed below.

### DETAIL DESCRIPTION OF THE INVENTION

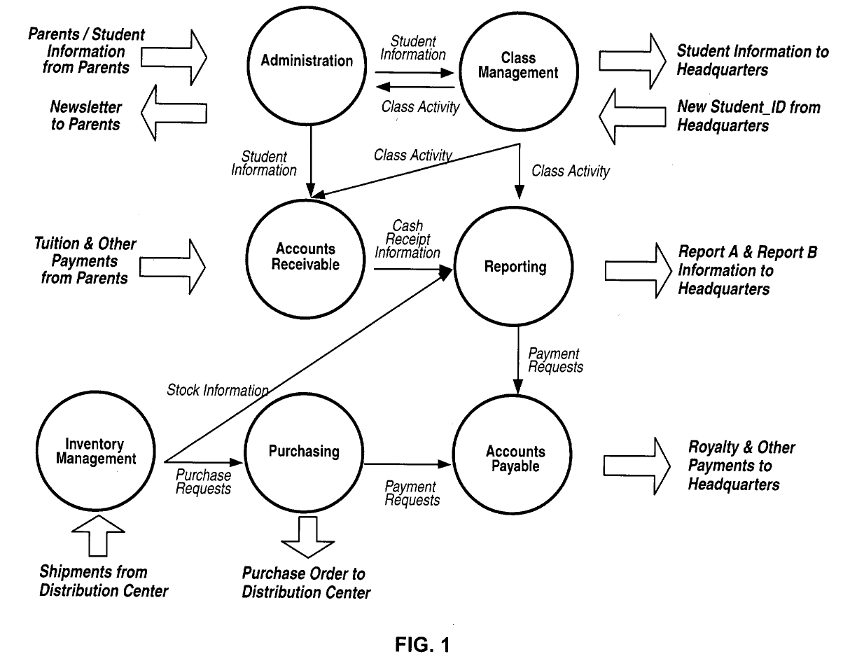

As illustrated in FIG. 1, an educational system of the present invention can often be divided into five major functional groups:

1. Administration

One of the functions of the administration is to manage the flow of information to and from students and their parents. For example, the administration processes applications by new students as well as information regarding existing students. The administration usually provides regular reports to the parents, including for example, newsletters and monthly statements.

Administration typically processes new students and transfers to enroll them into the courses of the training center. Administration may also handle certain functions for existing students. For example, the administration may: conduct a pre-enrollment interview of new students; administer diagnostic tests to new students; enter the diagnostic test into a computer database, or cause the results to be entered into the database (diagnostic test may taken on a computer linked to the database, or may be scored using a reader linked to the database); enter the oral reading test results into a computer database; conduct oral reading tests; administer achievement tests for transfer students; provide an initial set of progress goals for new students; provide printed progress goals for existing students; communicate regularly with parents regarding the performance of new and existing students; provide documentation and student records for out-going transfer students and students who have completed their training programs; and enrolling new students by helping them to complete application enrollment forms.

2. Class Management

A primary function of class management is to manage the everyday aspects of the classroom. For example, class management involves monitoring and recording the daily assignments of the students as well as their test scores. Class management becomes more complicated as the number of students increase, and as the degree of individualized instruction is increased. Class management is essential to helping instructors plan their daily lessons.

Class management preferably: updates progress graphs on a regular basis (monthly and/or weekly where appropriate); has students correct errors made on their worksheet so that they learn from their mistakes; records worksheet times and scores for all students, including homework and class work (assignments may completed on a computer linked to a database, or may be scored using a reader linked to a database); ensures class work is graded and errors corrected before students leave the center; has students read aloud on a regular basis as needed; provides guidance to students; encourages students to complete and correct work independently; provides lesson planning on a group and individual basis; makes sure students perform assignments in the order prescribed for the individual student; and gives achievement tests upon completion of each educational level.

3. Accounting

Accounting monitors and manages accounts receivable, accounts payable, and reporting. Preferably, accounting should maintain a tuition collection list and should generate accounting information on a periodic basis. Accounting may also generate business plan lists, general accounting reports, tax information reports, tuition collection reports, and payment information reports.

4. Purchasing

Purchasing should monitor and maintain a purchasing schedule and periodically generate a purchasing schedule list based on daily usage information provided by inventory management.

5. Inventory Management

Inventory management should monitor and maintain current listings of the inventory of critical school supplies, including for example, worksheets. Preferably, inventory information is updated automatically according to the worksheet usage.

It is preferable that each training center provides the most efficient educational environment for each of its students, regardless of age, level or grade. Each student should be assigned the appropriate level of materials to permit the student to perform at his or her own pace of study by dedicated instructors. Preferably, each instructor receives and uses regularly updated instruction manuals, to guide the instructors in defining the appropriate course of progress for the students. Preferably, the manuals outline instructions for each level of assignments. Having all instructors work from the most updated instruction manuals will also help to standardize and maintain quality control from training center to training center.

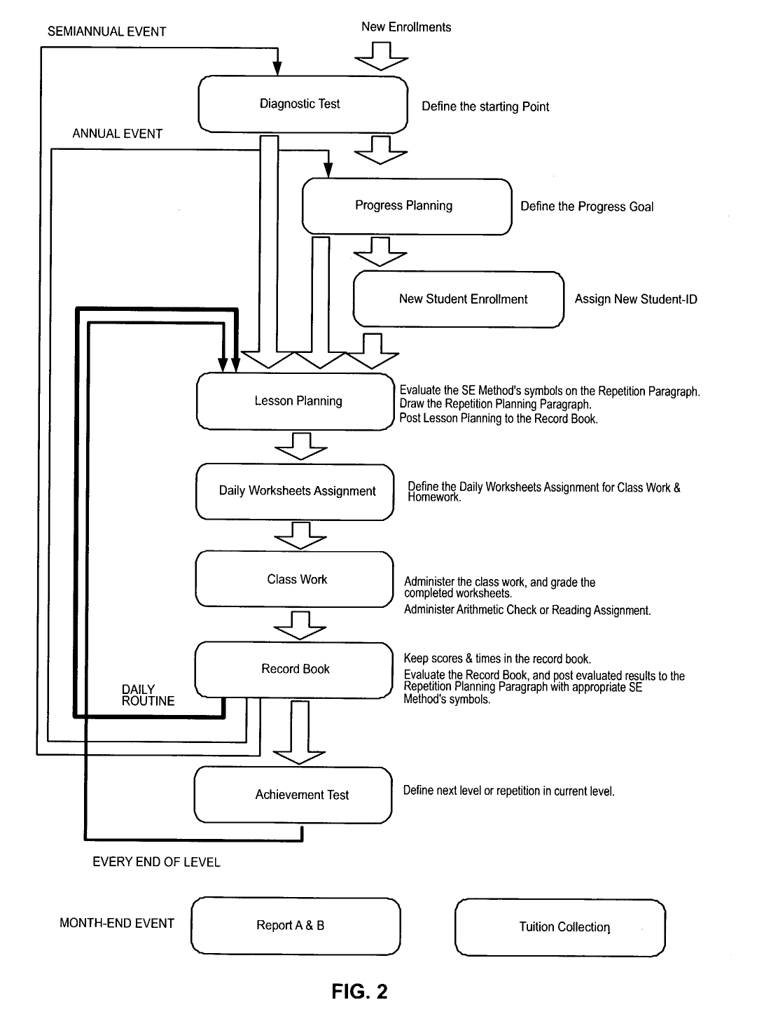

As shown on FIG. 2, new students seeking to enroll must take diagnostic tests, which tests help to define the level of material that the student should use in a study plan. Using the results of the diagnostic test, an instructor can define the appropriate starting level and provide progress planning for future assignments. As part of the new student enrollment, an applicant will be assigned a unique New Student ID, which will be used to identify the student and to track the student's information.

Diagnostic tests, however, may not be limited to new students. Preferably, diagnostic tests may be used periodically (for example every six months) to check for any areas of weak performance. Similarly, progress planning is not limited to new students, and instead, may be used preferably annually to define the progress goals for each student.

As shown on FIG. 2, there is a daily routine for each enrolled student. The instructor provides a lesson plan for each class day. The lesson plan comprises a listing of daily worksheet assignments for each of the students, and may also include homework assignments. The student completes the daily worksheet assignments in class, and the instructor makes sure that the assignments are graded and any mistakes corrected. The student's grades for the daily worksheet assignments are recorded on a computer database. Preferably, detailed records are maintained for each assignment, including worksheet level, worksheet number, time usage, and score. The recorded data, as maintained in a computer database (and which may be duplicated in whole or in part on a non-computerized manual backup) may be easily shared with other components of the present invention so that the system may provide, for example, Daily Record Lists, a Repetition Report, a Progress Graph, and a Periodic Progress Report. In addition, tracking the education progress and performance of individual students, the present invention can utilize the recorded data to assess and manage (1) accounts receivable, including tuition collection and/or royalty payments from licensed education centers; (2) inventory management, including predicted and actual usage of consumable education materials, and (3) lesson planning, including assessing which students will attend a particular class session, determining which lessons are to be taught based on the students' current level and worksheet, and highlighting any students requiring special or additional attention based on the recorded data.

When a student has completed all the assignments associated with a given current study level, an achievement test will be administered to define the next level and/or to define a need for repetition of one or more areas within the current study level. Once a new level is assigned, the student will need a new set of progress goals that is customized for the new level.

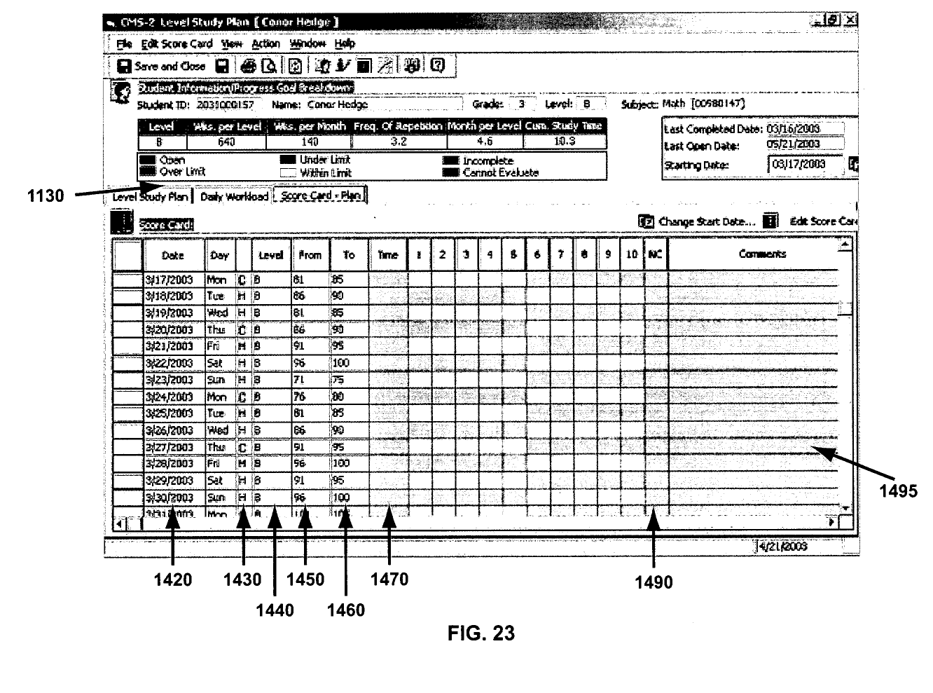

FIG. 2 also illustrates that regular reports (e.g., Reports A & B, and the Tuition Collection report) can be generated using a plurality of student records. Reports showing the quantity of worksheet being used by students can also be generated, which can then be used by Purchasing to place new purchase orders, for example, by automatically generating purchase orders. Purchase orders can also be generated for specific worksheets, taking into consideration the prior rates of usage and/or the number of students who have a particular worksheet in their progress plans. Inventory reports can be generated periodically and/or on demand, using the information contained in the computer database. FIG. 23 illustrates one type of periodic report that may be generated using the present invention.

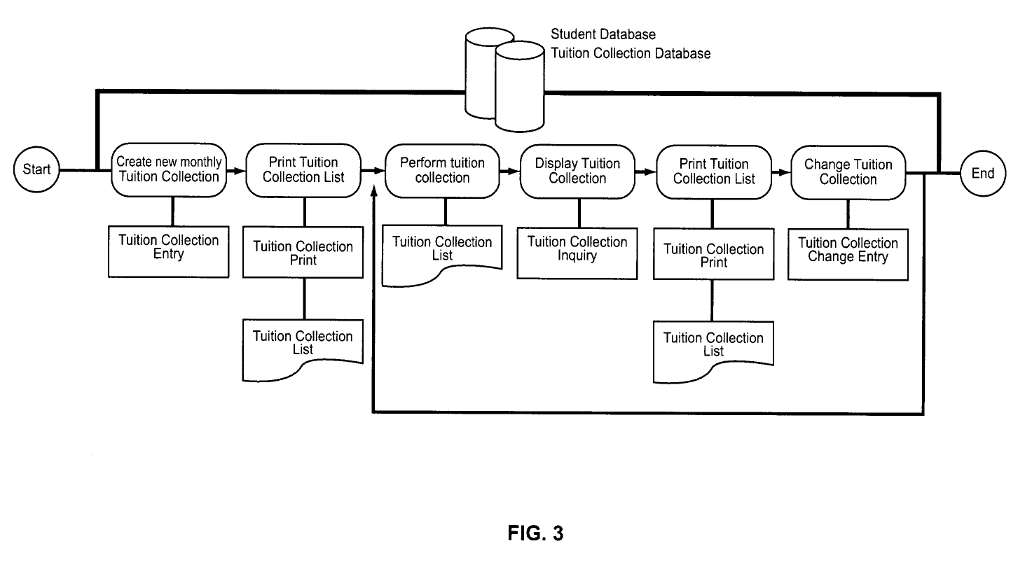

FIG. 3 illustrates the steps that may be taken to generate a tuition collection report. The user must first enter the time period for which tuition collection is to be processed (e.g., by specifying a month). A tuition collection list may then be generated, upon which a tuition collection query may be performed in order to display or print a tuition collection report. Once generated, the system also provides the user an opportunity to make changes.

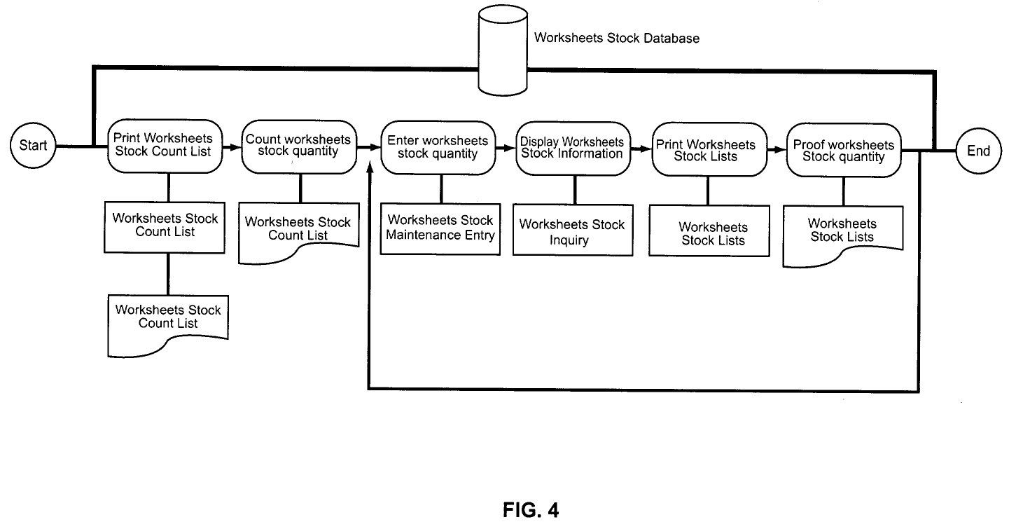

FIG. 4 illustrates steps that may be taken to generate an inventory report for worksheets. The user may print a worksheets stock count list, which is a listing of the quantities, by worksheet numbers, that the system has calculated to exist. A user may also enter the actual quantity of each type of worksheets based on a physical count of the worksheets in inventory. This will permit the system to update its records for greater accuracy in the future. Once revisions have been made, if any, the system can display all, or a subset, of the quantities of the worksheets for the inventory control person to use. While not pictured, the system can also accommodate the automatic generation of purchase orders for any particular worksheets when the quantity falls below a predetermined threshold.

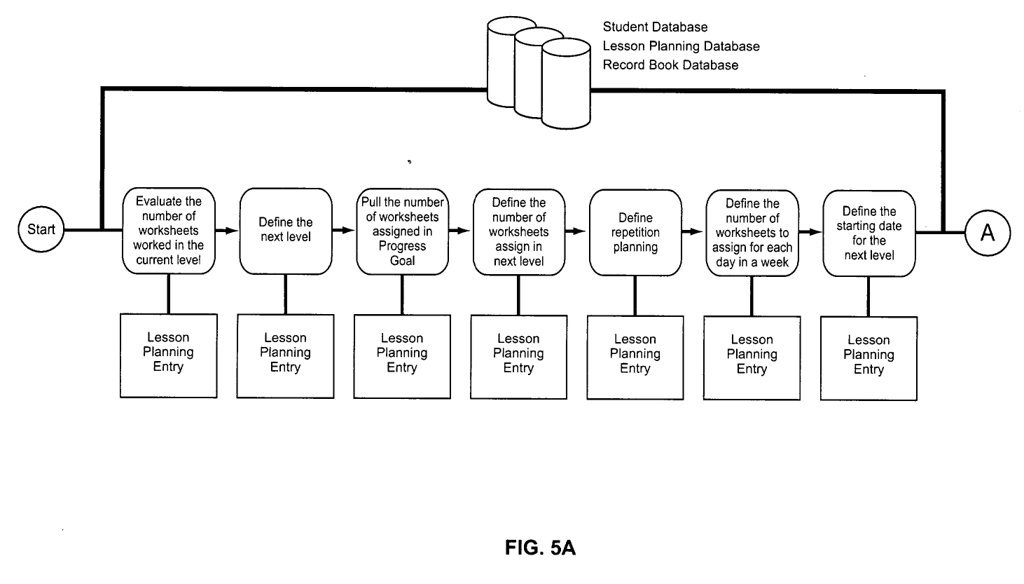

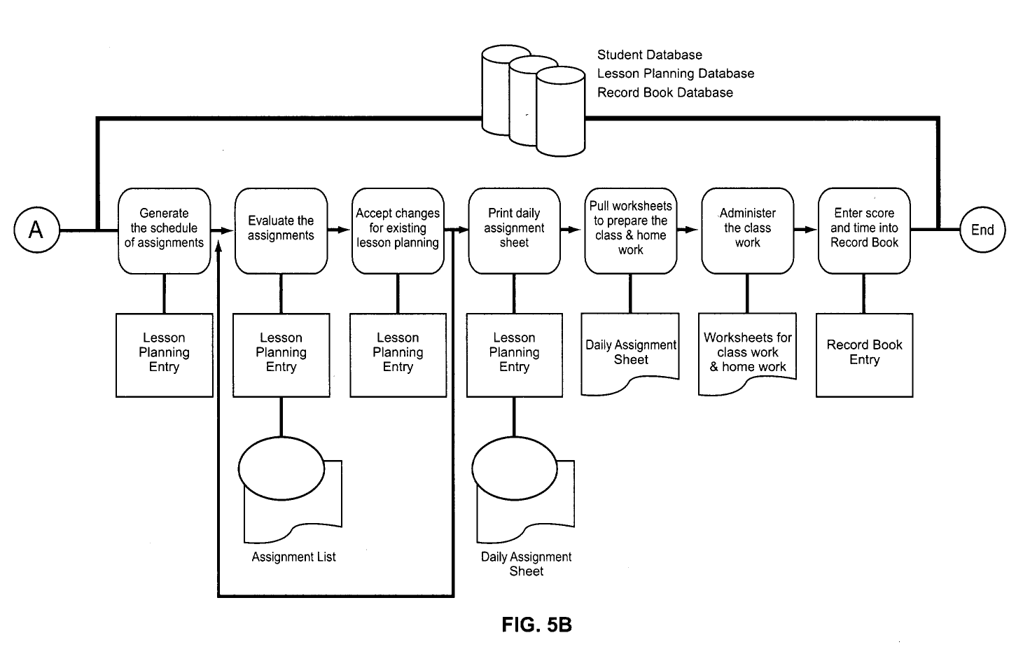

FIGS. 5A and 5B illustrate some of the functions of the present invention that assist the instructor in preparing for class session. For example, an instructor may specify the number of worksheets to be completed in a given level. If the student is starting at the beginning of the level, then the number will be the total number of worksheets for that level. If, however, the student is starting at an intermediate position within a level, then the number will be based upon the total number of sheets for a level, less the number of worksheets for which the student has been given credit. The instructor may also specify the next level (which usually is the next level up, but can vary depending on whether the student is receiving instruction in specific areas), and the total number of worksheets to be completed in the next level (which number may depend on whether the student has been given any credit for performance in some areas of the next level). The instructor may also define a repetition pattern for one or more levels, which is designed to require certain subject matter lessons to be periodically repeated for reinforced learning. An instructor may also specify the number of worksheets that a student may be expected to complete in a given time period, as well as specific target dates (for example, a starting date for starting instruction at the next level). Based on information input by the instructor, and optionally based upon supplemental information contained in the computer database for the individual student, the system can generate a worksheet assignment schedule for a student to tell her which worksheets should be completed and when. The instructor preparation module of the present invention uses the information entered by the instructor and stored in the computer database for determining which students are scheduled to attend a particular class session, what consumable educational materials are required for the particular class session, and which if any students do not have predetermined assignments for the particular class session.

FIGS. 5A and 5B also illustrate that an instructor may regularly evaluate a student's performance and make adjustments to her individual lesson plan based on the evaluations. The system can also be setup to automatically make adjustments to a student's lesson plans whenever daily performance information is updated.

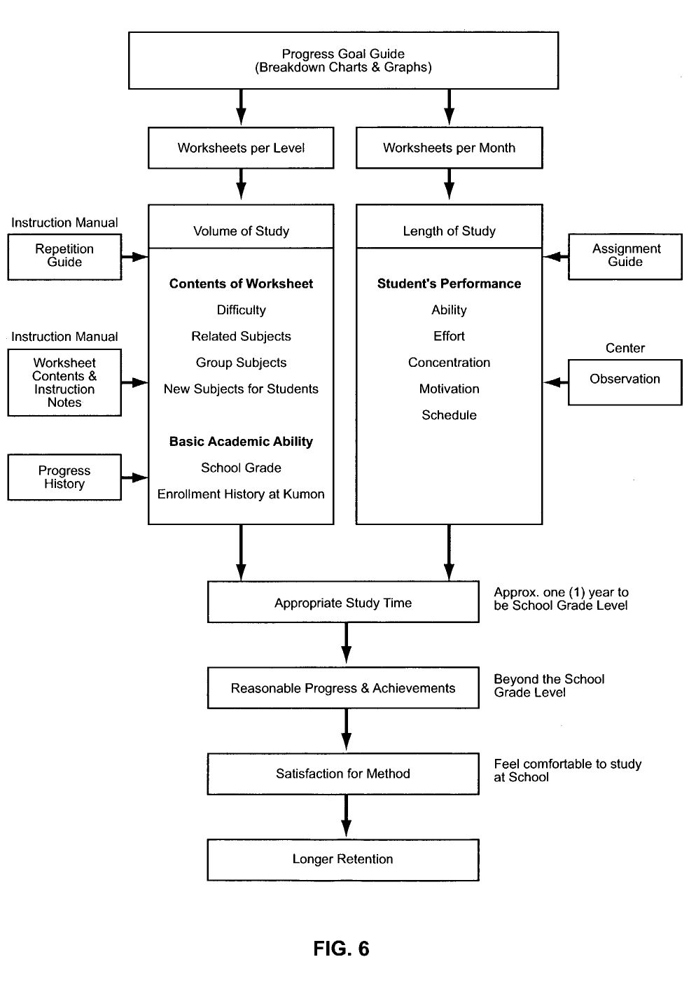

FIG. 6 illustrates some of the more detailed implementation and use of progress goal breakdown charts and graphs as part of the integrated educational system of the present invention.

The recorded data for the students is preferably maintained in a relational database. A relational database will permit a user to change one piece of data which will cause other system functions to be automatically updated and/or regenerated using the updated data. The use of a relational database can help realize tremendous efficiencies for instructors, administrators, and accountants.

A technical advantage of the present invention is that it permits dynamic progress planning. Progress planning can be achieved using Progress Goal Breakdown Charts, Progress Goal Guide Graphs, and Repetition Guides. The dynamic aspect permits an instructor to revise the progress plan for any student individually, and as often as the instructor believes appropriate.

In one embodiment, the present invention uses a series of menus to take an instructor from an initial student record entry to a specific daily schedule of what assignments a selected student should be completing on a given day to meet an individualized, predefined set of progress goals. Once the student is assessed, preferably by diagnostic testing, the instructor can determine an appropriate starting point, and the progress goals menu can be used to create a set of progress goals based on a desired repetition plan. The progress goals may include a series of long-term goals (which may range from of months to years) for completing the one or more levels of the present invention. The study plan menu allows the instructor to adapt the repetition plan to the individual lessons and to correlate the long-term set of progress goals to the daily workload that is appropriate for the particular student. This generates a day-to-day student schedule that is displayed using the progress report menu. As the student progresses through the system, student progress data in the form of completed assignment data and achievement test results may be entered for the student. The progress report menu permits the actual progress of the student, as reflected by the progress data, to be compared with the set of progress goals. If the student does not perform as anticipated, the set of progress goals may be adjusted. Because the set of progress goals, the study plan, and the progress report are interactively linked, the instructor can enter updates or changes to anyone of the set of progress goals, the study plan, and the progress report and the present invention will automatically update any changes in the remaining data sets. To further enhance the monitoring of student performance, an instructor alert function is provided where an alert is generated whenever a student's actual performance falls below a predetermined threshold or whenever the student's progress data indicates particular areas requiring additional instructor attention for the selected student. Storing the underlying data in a relational computer database that is selectively accessed by the various menus to generate the selected displays facilitates the interactivity.

Student Record:

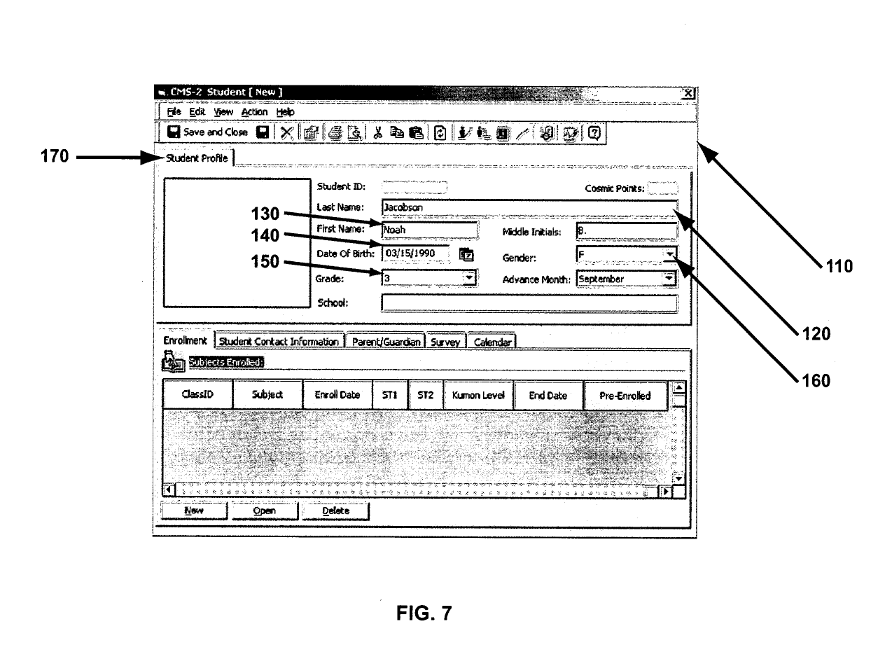

To initially enroll a student in the training program, historical student data must be collected to create a student record. As illustrated in FIG. 7, the present invention provides new student record creation menu 110 to permit an instructor to create a new student record. The information to be entered here may come from a paper Student Application form or may be directly entered into the computer system thorough a data entry device such as a keyboard. To permit the instructor to efficiently interact with parents and potential students, a pre-enrollment mode may be provided to minimize the amount of profile data required before allowing access to further functions of the present invention. Preferably a minimum data set must be entered to create a student profile, including the Last Name 120, First Name 130, Date of Birth 140, School Grade 150 and Gender 160, which is then saved to a new student record in a computer database by clicking on save button 170. This will permit the instructor to rapidly generate a sample set of progress goals and a study plan to demonstrate the potential benefits of the educational system to the potential student. When the student enrolls, a diagnostic test can be administered to the student and additional profile data, including the diagnostic test results, may be entered to complete the student record. A student identifier then optionally can be assigned to uniquely identify the student within the system, preferably a number or alphanumeric code automatically generated by the system or manually entered by the instructor.

Set of Progress Goals:

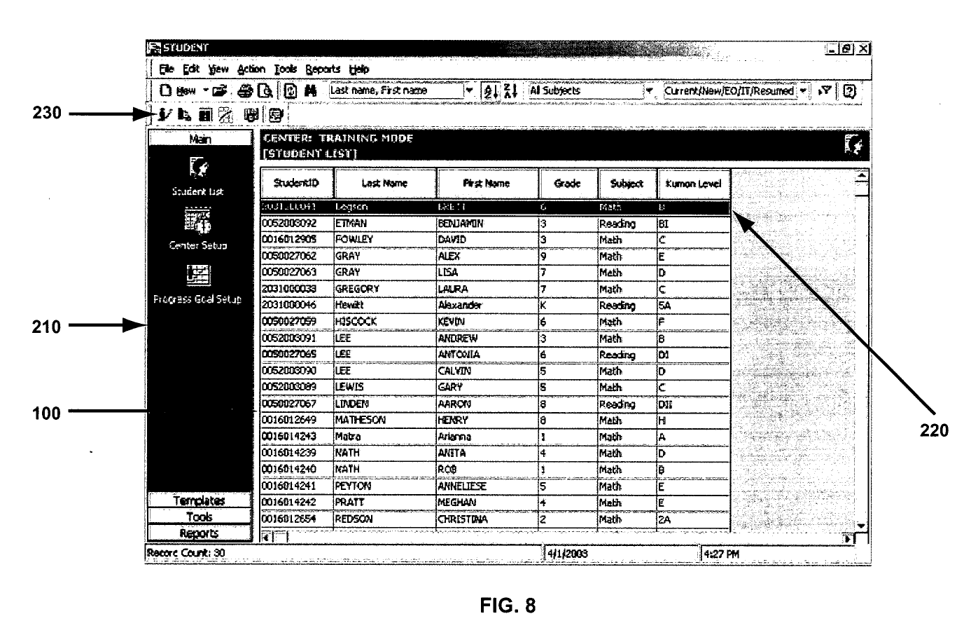

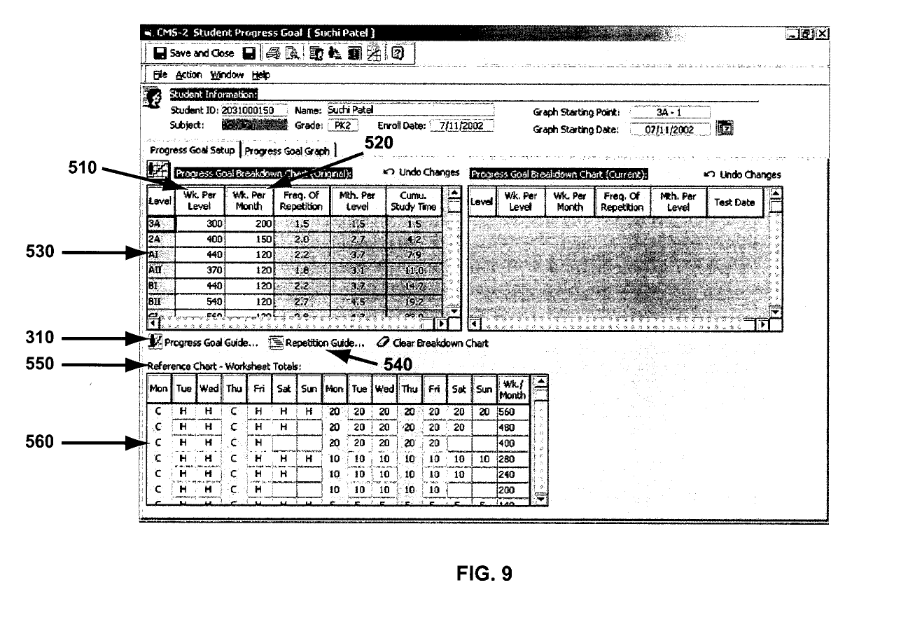

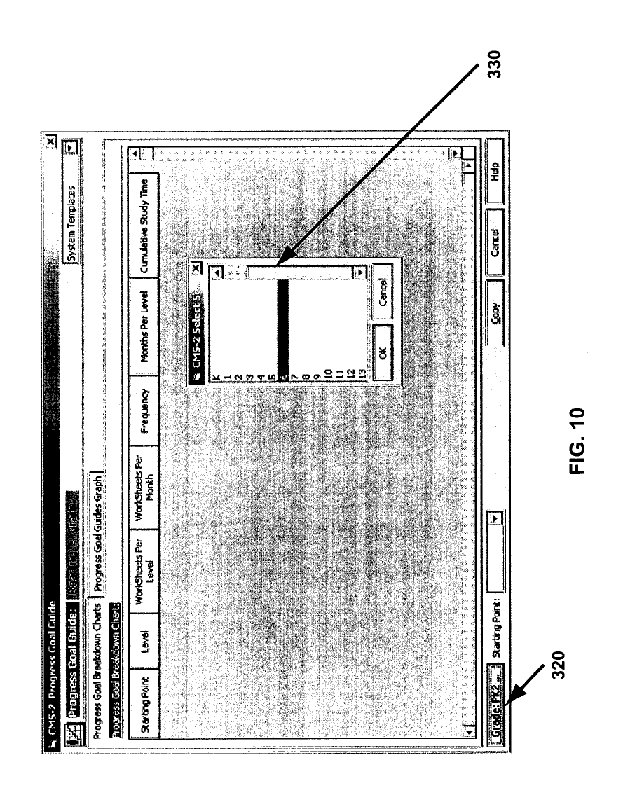

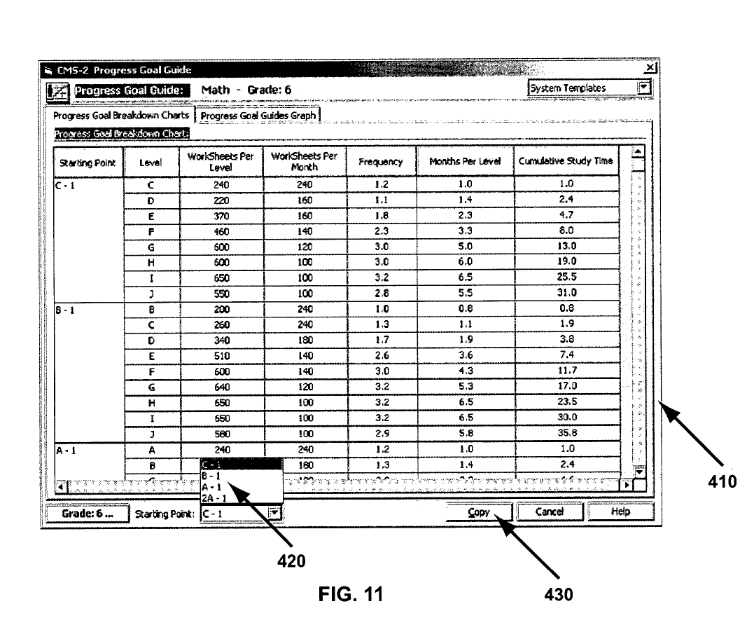

As illustrated in FIG. 8, each student should have a custom set of progress goals. This preferably may be accomplished rapidly by entering Progress Goal Menu 210, highlighting student name 220 on the student record entry, and then clicking Progress Goal 230. A default progress goal breakdown chart will then be presented on the computer monitor, based on the student's grade in school and the predetermined starting point. If a progress goal template does not automatically appear, the progress goal screen will come up blank. As shown in FIG. 9, a set of progress goals can then be manually created by clicking on Progress Goal Guide button 310, clicking on Grade button 320, shown in FIG. 10, and then selecting from pop-up list 330 a Grade which action will display on the computer monitor breakdown chart menu 410, depicted in FIG. 11, for the various starting points in the specified grade. The instructor can then select Starting Point 420 for the student and click Copy button 430. If the instructor confirms that he wants to use the progress goal template for this grade and starting point, the progress goal template is copied into the selected student record.

As illustrated by FIG. 9, the present invention permits the progress goal template to be modified by altering Worksheets Per Level 510 (which is related to frequency of repetition) and Worksheets Per Month 520 (which is related to the number of worksheets done per day) by double-clicking on any cell. Up and Down arrows may allow manual adjustment of the numbers. Repetition patterns may be viewed while setting the set of progress goals by selecting level 530, and then clicking on repetition guides 540. A specific repetition plan can then be copied from the guides to the set of progress goals. A reference chart of worksheet totals 550 is preferably presented for reference so that the instructor can see the monthly totals of certain daily workloads in order to set the goal accurately. Changing the actual daily workload of a student is preferably completed in the Study Plan menu.

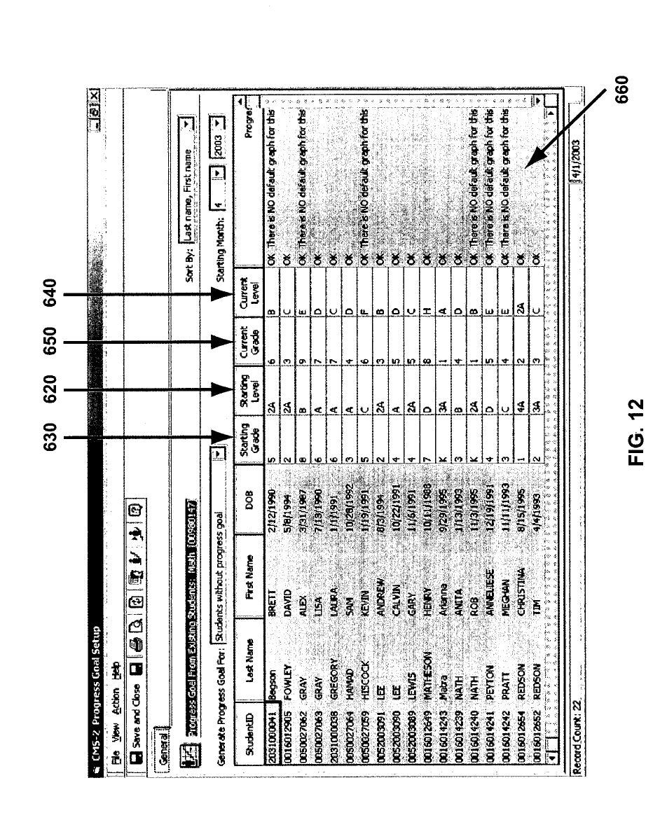

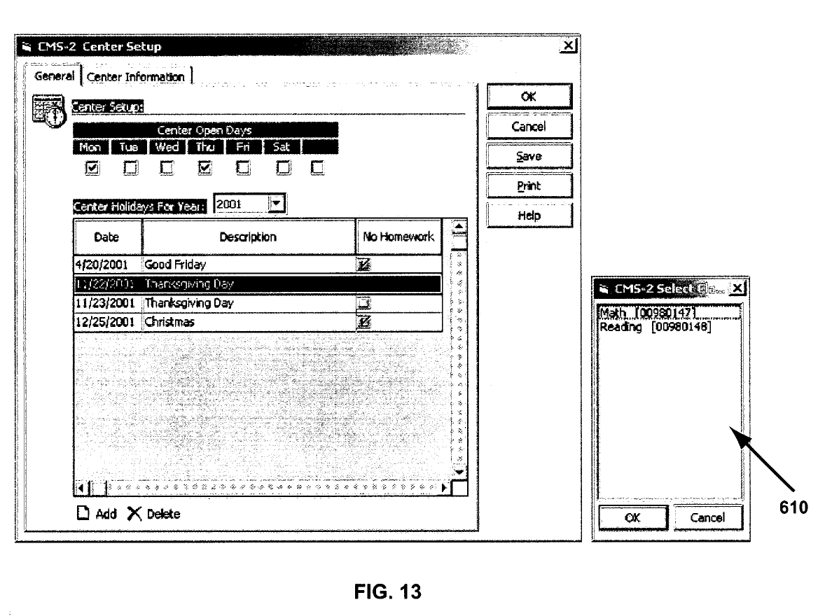

In the preferred embodiment, it is possible to generate a set of progress goals for: 1) students without goals, 2) all students, or 3) a selected student. As shown in FIG. 12, once the progress goals menu has been selected, the relevant information about the student—starting level 620 and grade 630, as well as current level 640 and grade 650—are presented to the instructor on a computer monitor. The screen also lists the current progress goal status 660 of the student to make it easy to see who needs a goal. As shown in FIG. 13, the instructor will be presented with a selector 610 to permit him to select which course, such as math or reading, he would like to create a set of progress goals for.

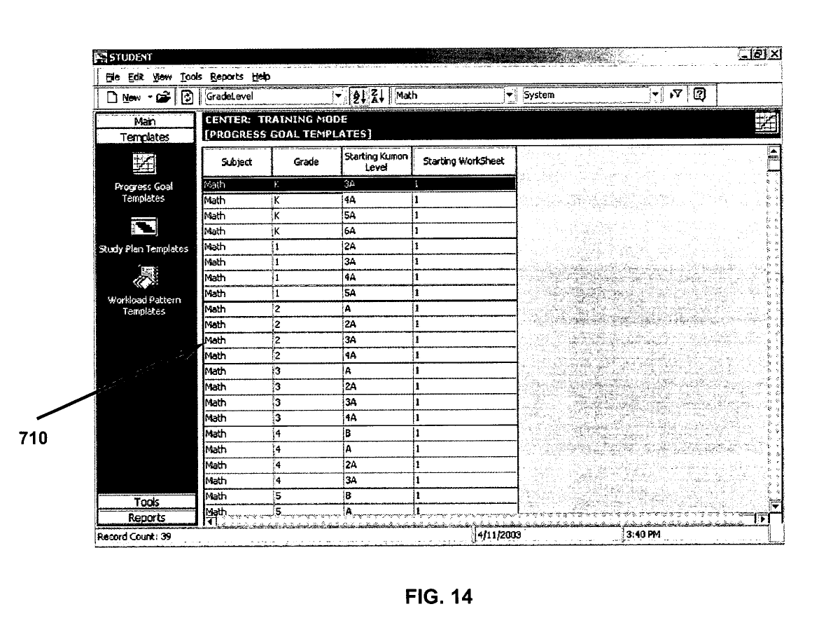

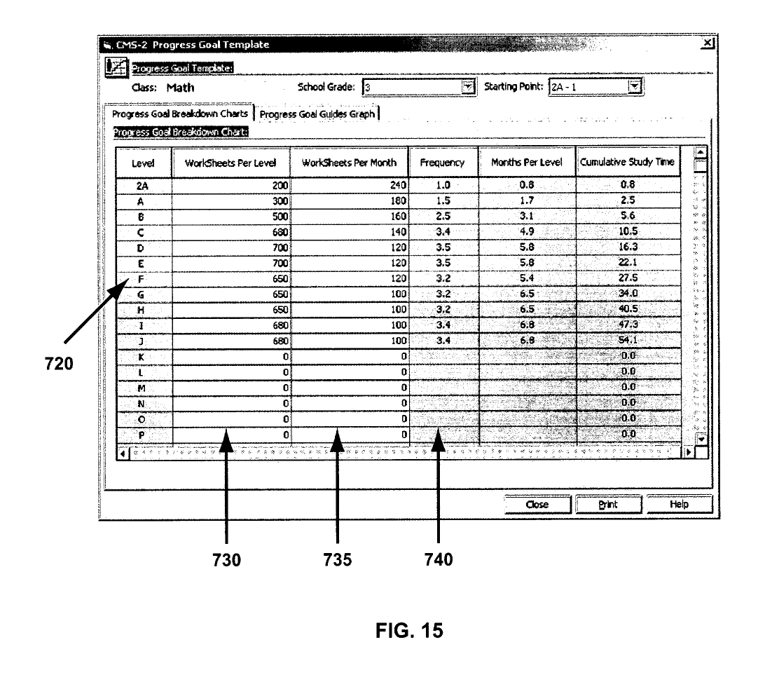

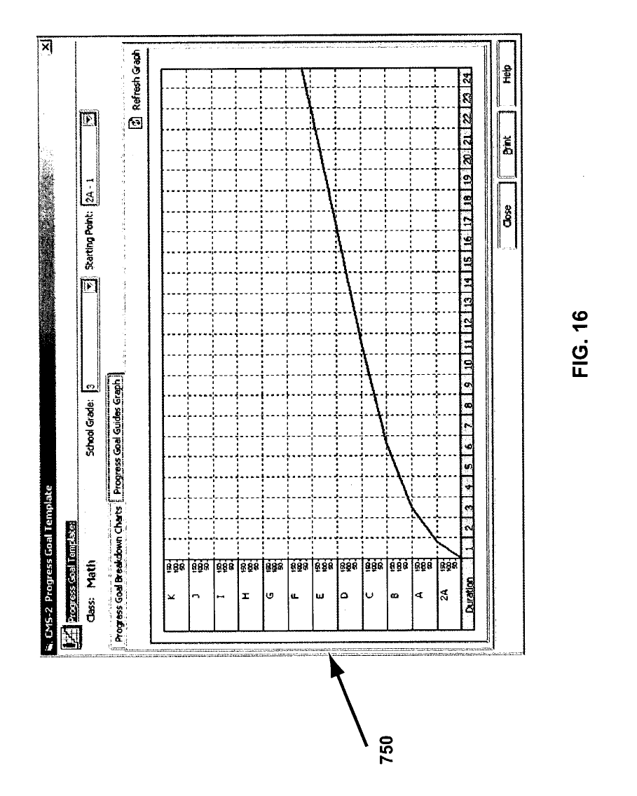

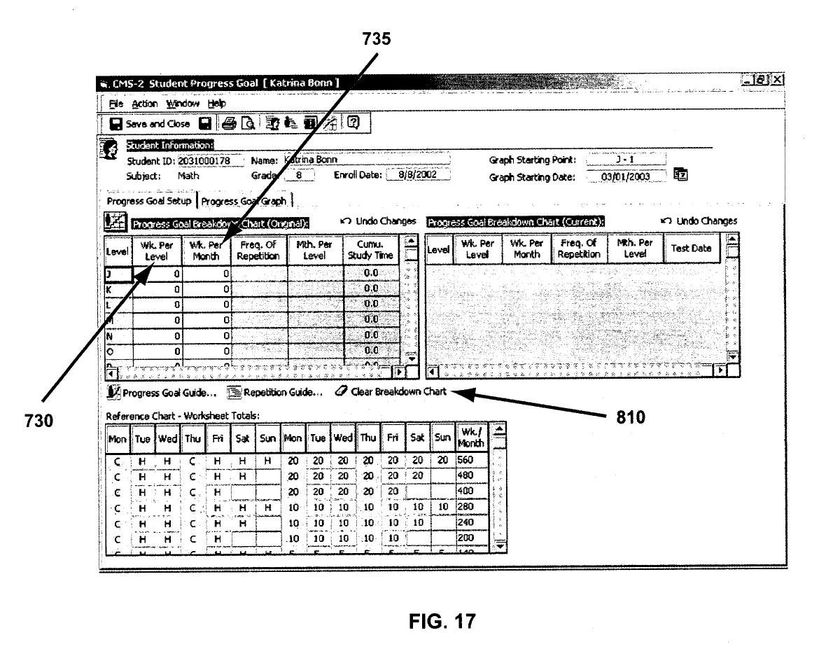

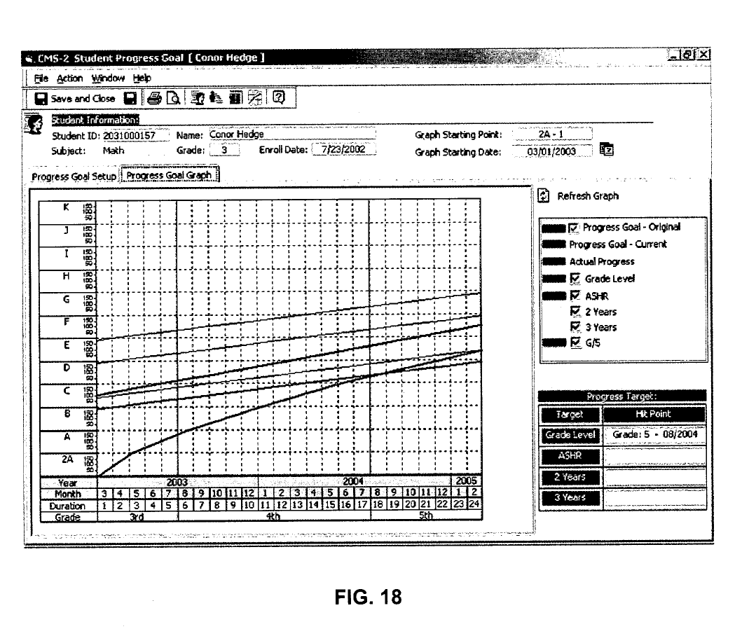

To assist the instructor in developing a set of progress goals for a student, a plurality of progress goal templates are selectable. As illustrated in FIG. 14, template list 710 displays all of the pre-programmed progress templates—created by either the system or the user. Templates are listed by grade and then by starting point within the grade. Once a particular template is selected, preferably by double-clicking on a particular listing, the screen, shown in FIG. 15, will display the breakdown details 720 of the set of progress goals, including worksheets per level 730 and repetition plan 740. The instructor can change either the worksheets per level 730, or the worksheets per month 735, thereby creating a customized set of progress goals. If the instructor desires to reuse the modified set of progress goals for other students, he can optionally save the modified set of progress goals as a new progress goal template. It is also possible in the preferred embodiment to display the progress goals information in graphical format 750, as shown in FIG. 16. Alternately, as shown in FIG. 17, the instructor can create an entirely new template by clicking on Clear Breakdown Chart button 810 and manually entering the Worksheets per Level 730 and Worksheets per Month 735. Because the inputs are inter-linked with the progress goals graph 750, any instructor changes will automatically be reflected on progress goal graph 750.

Study Plan:

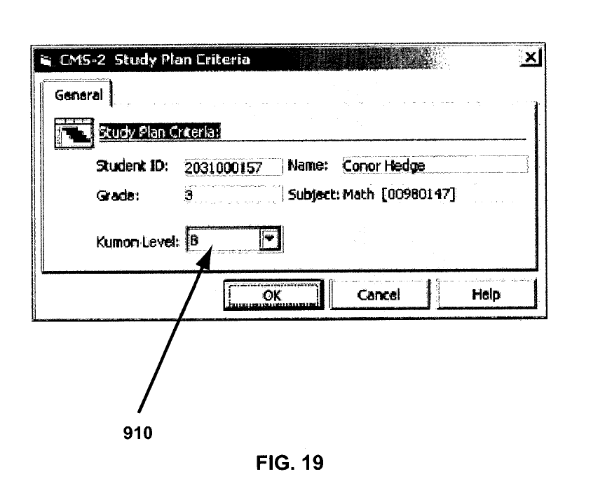

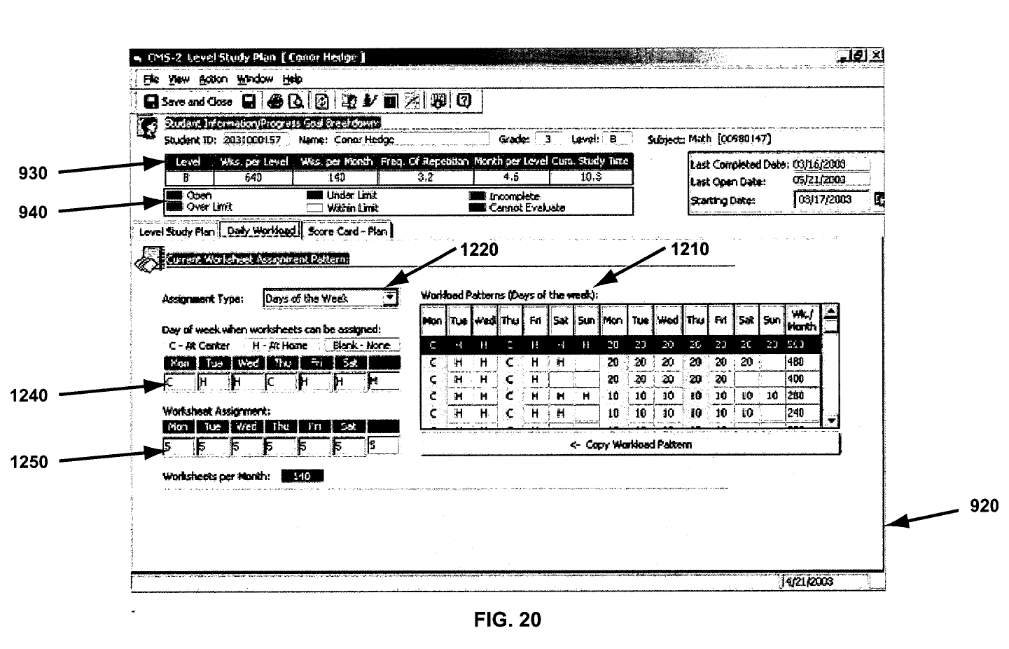

Once a set of progress goals has been established, the instructor will want to create a study plan for the student to meet the set of progress goals. From the default student data menu 100, shown in FIG. 8, the instructor can select a student and then choose level 910 to create a study plan for the selected student, as depicted in FIG. 19. Study plan menu 920 will then be displayed on the computer monitor, as illustrated in FIG. 20, which will preferably display progress goal information 930 and color-coding 940.

In a preferred embodiment, each assignment or worksheet completed is graded and a scaled score and a time for completion is recorded. Color-coding 940 can be used to provide a quick graphical reference to display the student's performance on the assignments completed including whether a satisfactory scaled score was achieved and whether the assignment was completed within a predetermined time. As would be understood by one of ordinary skill in the art, various color-coding schemes can be used to vary the level of detail provided by the graph, using for example multiple colors to represent a plurality of scaled score ranges or time thresholds.

An exemplary color-coding scheme is as follows:

When a level study plan is first entered, it appears in blue, which color indicates that it is planned but not completed. Once work has been completed (as would be evidenced by updates to the progress report), the present invention will assess and color-code a portion of a graph as follows:

Green—completed in under x time and with acceptable scores

Yellow—completed between x and y time with acceptable scores

Red—completed in over y time and/or with unacceptable scores

Grey—incomplete assignment

Brown—unable to assess (i.e., no time or incomplete set of responses)

Preferably, the present invention adds a certain amount of correction time to the student's completion time. This formula takes into account the student's original completion time as well as the number of errors. The additional time is taken into account when color-coding, but the student's time will not be altered in the progress report.

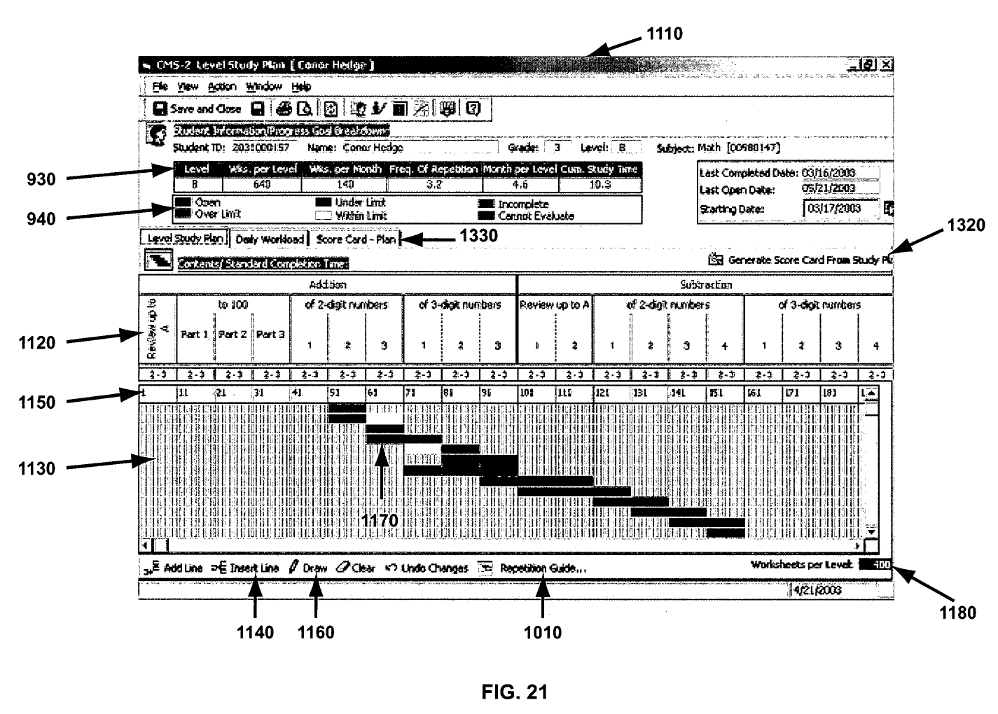

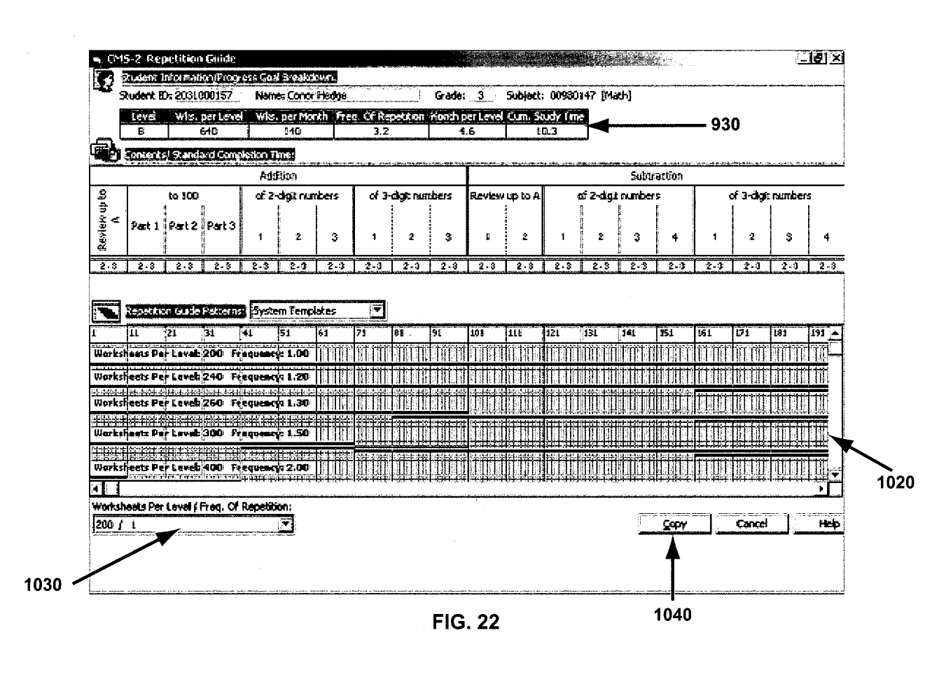

In a similar fashion to the progress goals template, an instructor can choose from a list one or more study plan templates when setting up the study plan for each student. The study plan templates are typically listed by level, and within each level, by frequency of repetition. The frequency of repetition sets the frequency at which the individual assignments or worksheets will be repeated to reinforce the concepts with the student. The instructor may select one of the displayed study plan templates, preferably by double clicking on any listing to view the details of the study plan template. Preferably the present invention selects as a default study plan template, that template which most closely matches the repetition plan selected initially when setting the set of progress goals. The present invention may also make available for selection other study plan templates. As shown in FIG. 21, the predefined study plan templates offered for a given level may be viewed by clicking on Repetition Guides button 1010. The instructor is then able to select study plan template 1020, as illustrated in FIG. 22, for example by choosing the default template or one of the other listed templates. Selection is accomplished by clicking on listbox 1030, selecting the desired repetition plan, and then clicking Copy button 1040. The selected repetition guide will appear on the student's Level Study Plan 1110, as shown in FIG. 21. The simplified breakdown chart 930 found at the top of each student's study plan menu acts as a reminder of how much repetition was originally expected for this student in that level.

Similar to the customization made available by the progress goals menu, the study plan menu preferably permits the instructor to modify the study plan created using study plan template 1020 and to save it as the study plan for the selected student or as a customized study plan template for use with other students, or both. Once a study plan template is selected, the present invention displays the details of the study plan, including for example learning focus reference bar 1120, as shown in FIG. 21, which displays the details of the relevant study level (showing, for example, the study subjects for the level). Additional information can be included about each section to aid the instructor in tailoring the study plan to the particular subject. For instance, if a new or particularly difficult subject is introduced in a particular section, more repetition may be warranted. Additional information and tips for the instructor for a particular section are preferably presented via hyperlinks and pop-up windows as are well known in the art.

Study plan lines 1130 graphically display the repetition plan selected for the particular study level or levels displayed. To draw additional Study Plan lines, the instructor may click on Insert Line 1140 (which inserts lines above). Study plan lines may be adjusted using draw function 1160 and by conventional click and drag of study plan lines 1130 using a computer mouse along the grid under the set numbers 1150. Preferably, double-clicking on a cell (e.g. cell 1170) will auto-draw in ten-worksheet increments. Double-click again and it will auto-delete. Such a graphical editor will permit an instructor to add or delete in ten-worksheet sections any study subject shown in learning focus reference bar 1120. The worksheets per level 1180 are displayed and will automatically be updated for any alteration to the Study plan lines. This total may be compared to worksheets per level 730 for the set of progress goals to see if the study plan is consistent with the set of progress goals. This comparison can either be performed by the instructor or automatically by the present invention. The present invention can then (1) present an alert to the instructor to reflect any inconsistency between the two values for worksheets, (2) issue an alert only if the difference exceeds a predetermined threshold, or (3) automatically adjust the worksheets per level 730 to match the instructor-entered study plan worksheets per level 1180. Once the repetition plan has been set for the various sections, it is necessary to correlate the repetition plan with a specific student schedule based on the particular student's workload pattern, i.e., how many days per week will the student be in class, how many days per week will he work independently, and how many assignments or worksheets can the student reasonably complete in a given class and at home for a particular section. Here too, the present invention assists the instructor by providing daily workload combinations 1210, as shown in FIG. 20, that are pre-programmed into the present invention. Workload combinations follow assignment type 1120 that may be based on days of the week, or an alternate cycle that may include a pattern of workdays and days off that may not neatly follow the calendar week. An instructor can either select one of the listed workload combinations 1210 or can manually select assignment type 1220 and enter day of the week when worksheets can be assigned 1240 and worksheet assignment 1250 for those days.

Progress Report:

The progress report (also known as a score card) reflects the daily performance of the selected student on assigned worksheets and completed achievement tests and is closely linked to the study plan because the student schedule provides the basis for comparing the actual performance of the student as reflected by progress data entered on an ongoing basis and the expected performance based on the set of progress goals. The progress report menu 1410 will be blank until a study plan is created. The progress report may be generated by clicking Generate Score Card from Study Plan 1320 from the Study Plan menu as shown in FIG. 21. Alternately, the progress report can be automatically generated either as the study plan is entered or when the study plan is saved to the computer database. As shown in FIG. 23, once generated, the progress report 1410 will display date 1420, the nature of the assignment 1430 (i.e., classroom or homework), current study level 1440, starting worksheet 1450 for a given date, and finishing worksheet 1460 for the same date. Preferably, the daily assignments are listed in chronological order on the Score Card/Progress Report. The instructor can alter the order of particular assignments to allow for certain pivotal sets to be introduced in class. This can be done manually by selecting the set assignment and changing its planned date. Preferably, the study plan and progress reports are interlinked, and so, if any such alterations are made to the progress report, the study plan automatically will be adjusted to match.

As the student completes assignments and takes achievement tests, student progress data is entered directly into progress report 1410. Data entry can occur automatically if the tests are conducted using a computer that is linked to the relational database, or if the test results are scored using a scoring machine linked to the relational database. Alternatively, the data can be entered into progress report 1410 using an input device such as a keyboard. This screen allows the instructor to see each student's entire progress report. The student's time 1470 and worksheet scores 1480 may be entered into the progress report by clicking on the score buttons 1480 or if the student has scored a perfect set, by clicking on the Perfect Score button. Scores or times for assignments using non-standard scoring may be entered in block 1490. Additionally, the instructor may enter a short comment about the student or his performance on a particular set, i.e., “counting on his fingers,” into comment field 1495. These comments will appear on the Instructor Alert and the Instructor Preparation Report.

Instructor Alert Report:

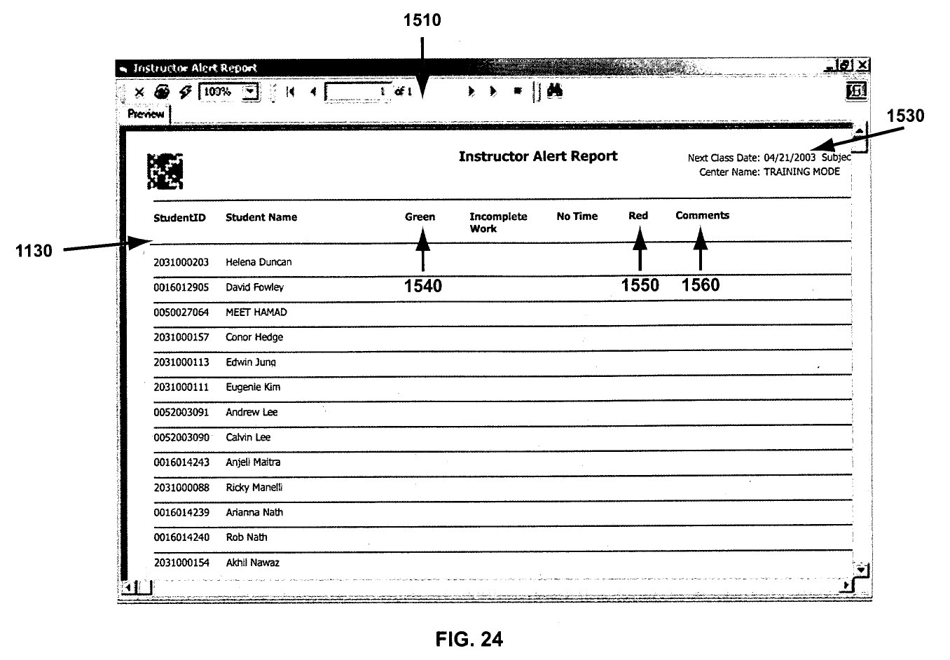

FIG. 24 illustrates how Instructor Alert Report 1510 is designed to draws the instructor's attention to students who may need to have their study plan adjusted, or who may need extra attention during class, using information from the Lesson Planning Assessment feature—and who may need more or less repetition based on their performance. The report may display achievement tests scheduled for date 1530 and may show students meeting various instructor alert criteria that are stored in an instructor alerts database. These criteria preferably utilize the exemplary color-coding scheme discussed above and may visually identify those students whose work falls into certain performance ranges as indicated by color. For example, students whose progress is color-coded green 1540 may be listed for praise while students color-coded red 1550 may be listed to prompt the instructor to spend additional class time on the specific areas of difficulty. The color categories may also be used by the instructor to adjust the repetition plan, decreasing the repetition for green students and increasing the repetition for red students. In addition, any comments entered on individual student progress reports will be shown at 1560.

Adjustments to Set of Progress Goals, Study Plan, and Progress Report:

If a student is not progressing as planned, it may be necessary to adjust their set of progress goals. This can occur if a student is progressing either faster or slower than anticipated. Preferably, adjustments to the set of progress goals are made when the instructor is setting up the study plan for a new level. Changes may be made by selecting the Progress Goal menu 210, highlighting the student's name 220, and clicking on Progress Goal 230. The instructor can then change Worksheets per Level 510 or Worksheets per Month 520 to accommodate the student's needs. Preferably, this will automatically adjust the Set of Progress Goals. Repetition Guides 540 can alternatively be used to adjust the amount of repetition for each level. The repetition chosen will automatically adjust the number of worksheets. In either case, the updated set of progress goals can be saved to the computer database.

Study plan adjustments are changes to the study plan as a result of student's completed worksheet assignments (or incomplete worksheet assignments). Adjustments can be made to the study plan 920. To adjust the number of worksheets per day, highlight the student's name 100 and select Study Plan and level 910. The instructor can then select progress report plan 1330. The adjusted number of worksheets can then be entered manually 1250 or a desired workload pattern 1210 can be selected.

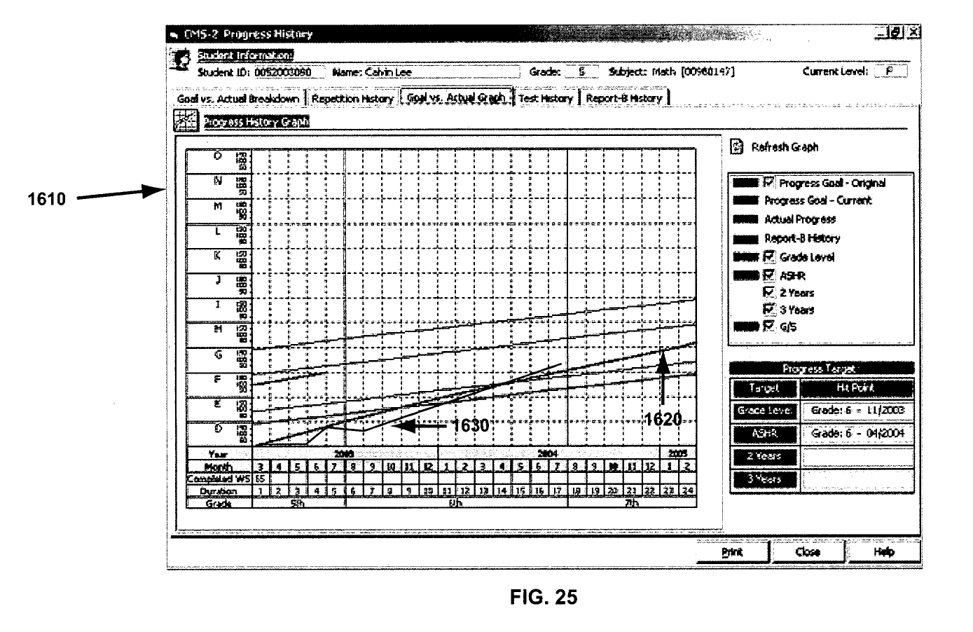

The present invention maintains student records for the entire time of study. If a student has the ideal situation, this will be reflected in their history. If a student consistently needs review, large amounts of repetition, etc., this will also be reflected in their progress history. For this to occur, however, the Instructor must make study plan adjustments in the student's record as the need arises. As shown in FIG. 25, the system can generate Goal vs. Actual Graph 1610 which provides a graphical depiction of students actual progress 1630 as reflected by his progress data for individual assignments and the expected progress 1620, as reflected by the set of progress goals. Preferably, when the set of progress goals is adjusted as described above, Goal vs. Actual Graph 1610 will automatically be updated to reflect the changes in expected progress 1620.

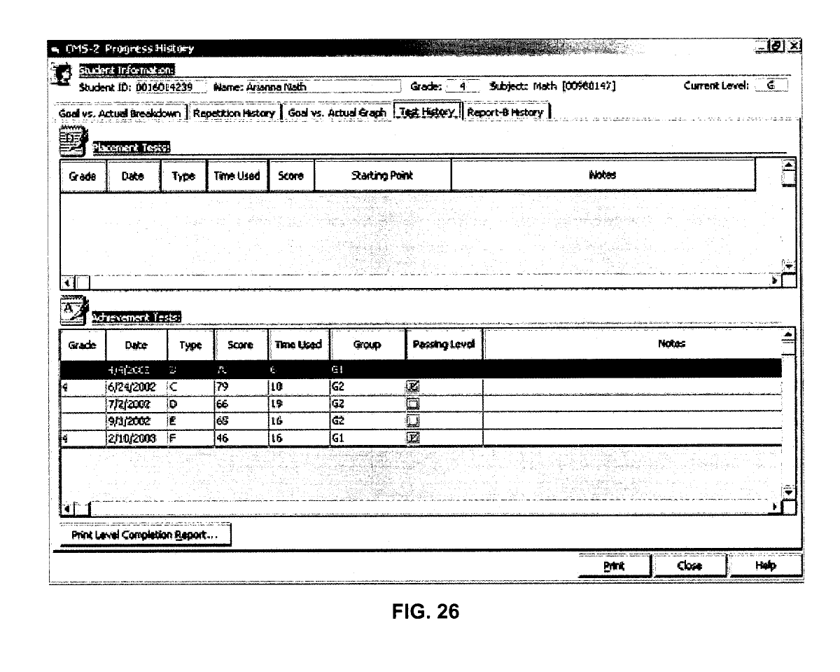

FIG. 26 displays the test history information available to the instructor for a particular student using the present invention. Both placement and diagnostic test results may be stored and referenced, preferably including the grade level, date of test, type or level of test, the score on the test, the time utilized for the test, whether or not the student received a passing grade, and any instructor comments regarding the exam. One of skill in the art will recognize that the test history data may optionally be aggregated and performance trends for a group or groups of students may be analyzed to assess the performance of a particular instructor, a particular testing center, or a particular demographic group of students (i.e. geographic location, age, etc.).

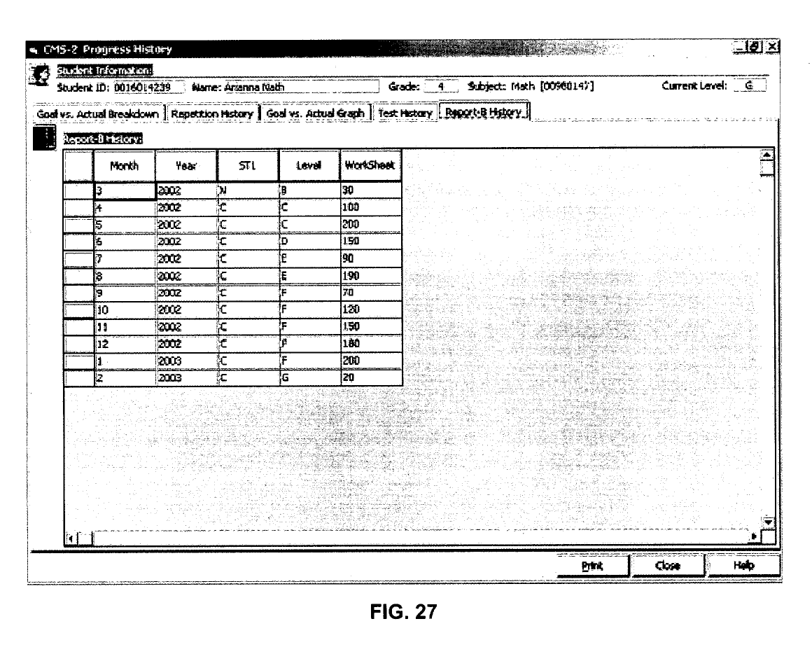

FIG. 27 shows an example of data that may be collected for a particular student or aggregated for a particular teaching center or a group of teaching centers. One of skill in the art will recognize that a wide variety of student performance parameters can be monitored and aggregated, including the exemplary historical information shown in FIG. 27, which include the student status, and student progress in the form of level and worksheet number completed for each month the student has participated in the educational system of the present invention.

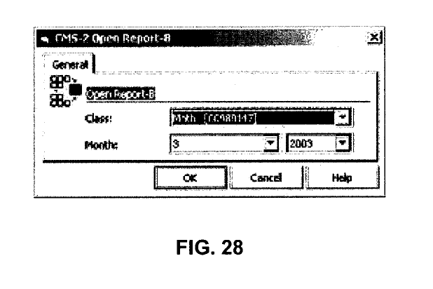

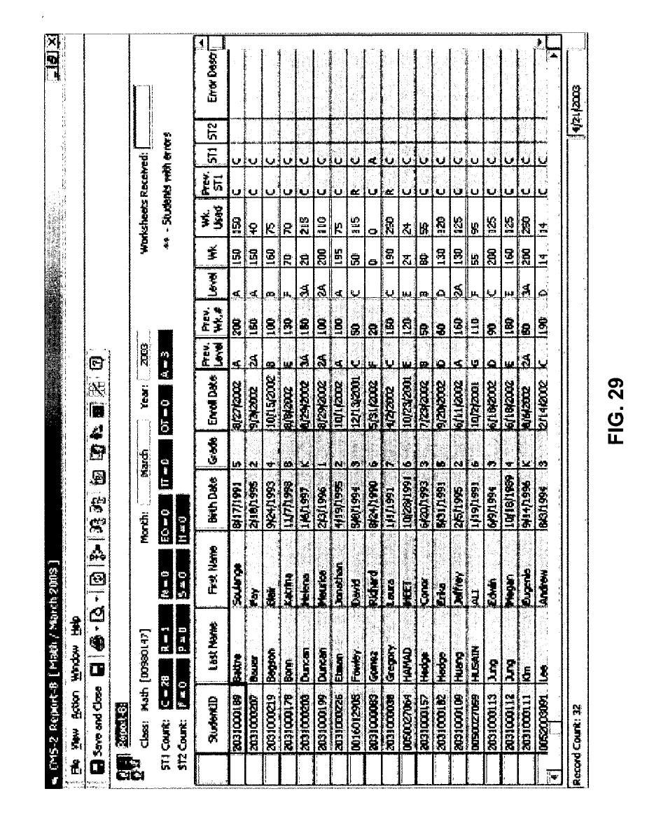

FIG. 28 depicts an aggregate report module that permits an instructor to generate an aggregate report for a particular class for a particular month and year. Once the instructor has selected the foregoing information, the aggregate report of FIG. 29 will be generated. Data for each student enrolled can be presented in tabular or other suitable format and may include student data from the student record, the current progress point (measured by level and worksheet number completed) and the progress point as of the last periodic aggregate report. The aggregate report may be used to monitor the progress of a plurality of students, to assist in inventory management by monitoring worksheet usage, and to assist in tuition collection.

Other embodiments and uses of the invention will be apparent to those skilled in the art from consideration of the specification and practice of the invention disclosed herein. The specification and examples should be considered exemplary only with the true scope and spirit of the invention indicated by the following claims. As will be easily understood by those of ordinary skill in the art, variations and modifications of each of the disclosed embodiments can be easily made within the scope of this invention as defined by the following claims.

What is claimed is:

1. An automated end-to-end business process for education that uses a relational computer database management system, the process comprising the steps of:
requesting an instructor to input diagnostic test data for a student into a student record in a computer database;
generating a set of progress goals for the student using the student record, the set of progress goals comprising one or more study levels, each study level comprising a plurality of assignments, assignment data for each of the one or more study levels, and an estimated timeframe for completing the plurality of assignments for each of the one or more study levels;
generating a study plan for the student, the study plan comprising a student schedule;
requesting an instructor to input student progress data for the student, the student progress data comprising completed assignment data and test results;
generating a progress report for the student, the progress report comprising the student progress data and any deviations from the study plan; and
storing the student progress data, the student record, the set of progress goals, and the study plan in the relational computer database management system.

2. The process of claim 1 wherein the step of generating a study plan further comprises:
selecting a predetermined repetition plan that repeats at least a portion of the plurality of assignments for one or more study levels; and
automatically revising the student schedule to incorporate the predetermined repetition plan.

3. The process of claim 1 further comprising:
automatically generating an instructor alert report, the instructor alert report identifying a student whose performance has dropped below a predetermined threshold and identifying areas that require instructor attention for the student;
requesting an instructor to input adjustments to the study plan for the identified student; and
storing the student progress data, the student record, the set of progress goals, and the adjusted study plan in the relational computer database management system.

4. The process of claim 1 further comprising:
generating a group report comprising student progress data for a plurality of students.

5. The process of claim 1 further comprising:
including in the student progress report a comparison of the student progress data to the set of progress goals for the student;
requesting an instructor to input adjustments to the progress report for a student based on a review of the comparison; and
automatically updating the study plan for the student based on changes input to the progress report.

6. The process of claim 1 wherein the step of generating a set of progress goals further comprises:
generating a set of progress goals for the student using one of a plurality of predefined progress goal templates stored on the relational computer database management system;
modifying the set of progress goals; and
storing the modified set of progress goals as at least one of a progress goals template and a set of progress goals for the student.

7. The process of claim 1 wherein the step of generating a study plan further comprises:
generating a study plan for the student using one of a plurality of predefined study plan templates stored on the relational computer database management system;
modifying the study plan; and
storing the modified study plan as at least one of a study plan template and a study plan for the student.

8. The process of claim 1 further comprising:
generating a report that compares a student's actual performance, as measured by student progress data, with expected progress, as measured by a set of progress goals.

9. The process of claim 3 wherein the step of requesting an instructor to input adjustments to the study plan further comprises:
requesting an instructor to input adjustments to a study plan of a student based on the progress report or the instructor alert report for the student.

10. A method of using a computer system to create a plurality of student records to be stored in a computer database, the method comprising:
presenting a plurality of functional menus to an instructor on a computer terminal, the plurality of menus including a new student record creation menu, a progress goals creation menu, and a study plan creation menu;
requesting, in response to the new student record creation menu being selected, an instructor to input historical student data for a student, the historical student data comprising diagnostic test data for said student;
creating a student record in a computer database for the student;
storing the historical student data for the student to the student record in the computer database;
assembling, in response to the progress goal creation menu being selected, a set of progress goals for the student, the set of progress goals comprising one or more study levels, a plurality of assignments for each of the one or more study levels, and an estimated timeframe for completing the plurality of assignments for each of the one or more study levels;
automatically assembling, in response to a study plan creation menu being selected, a study plan for the student, the study plan comprising a student schedule; and
storing the set of progress goals and the study plan to the student record in the computer database.

11. The method of claim 10 wherein the set of progress goals further comprises:
a repetition plan for repeating at least a portion of the plurality of assignments for one or more study levels.

12. The method of claim 10 wherein the step of assembling a set of progress goals further comprises:
assembling a set of progress goals for the student in response to the selection of a progress goal template from the computer database.

13. The method of claim 12 wherein the step of assembling a set of progress goals further comprises:
accepting input from an instructor to permit the set of progress goals for the student to be modified in accordance with said input; and
storing the modified set of progress goals in the student record in the computer database.

14. The method of claim 10 wherein the step of assembling a study plan further comprises:
assembling a study plan for the student in response to the selection of a study plan template from the computer database.

15. The method of claim 14 wherein the step of assembling a study plan further comprises:
accepting input from an instructor to permit the study plan for the student to be modified in accordance with said input; and
storing the modified study plan in the student record in the computer database.

16. A method of using a computer system to present information pertaining to a plurality of student records stored in a computer database, each of said plurality of student records comprising a student identifier and diagnostic test data for the selected one of the plurality of students, the method comprising:
presenting a plurality of menus to an instructor on a computer terminal, the plurality of menus comprising a student record menu, a study plan menu, a progress goals menu, and a progress report menu;
displaying on the computer terminal a selector to permit an instructor to select one or more of the plurality of menus;
accepting input through the selector, which input indicates the selection of the student record menu, said student record menu permitting an instructor to select at least one of the plurality of student records using the student identifier;
displaying the selected student record;
accepting student progress data for the student whose student record has been selected, the student progress data comprising completed assignment data and test results in accordance with a predetermined student schedule; and
assembling a progress report for the student using the student progress data.

17. The method of claim 16 further comprising:
accepting adjustments to the study plan for the selected student; and
automatically updating the progress report based on adjustments to the study plan.

18. The method of claim 16 further comprising:
displaying on the computer terminal a set of progress goals corresponding to a selected student record;
accepting modifications to the set of progress goals; and
storing the modified set of progress goals in the computer database.

19. The method of claim 16 further comprising:
displaying on the computer terminal a study plan corresponding to a selected student record;
accepting modifications to the study plan; and
storing the modified study plan in the computer database.

20. The method of claim 16 further comprising:
automatically assembling an instructor alert report for a student whose performance has dropped below a predetermined threshold, which instructor alert report identifies areas requiring instructor attention for the student; and
automatically displaying the instructor alert report on the computer terminal.

21. A method for measuring the educational performance of a student relative to predetermined educational goals comprising:
accessing data on a computer database relating to a student record;
accessing data on a computer database relating to a predetermined set of progress goals associated with a student;
accessing data on a computer database relating to a predetermined study plan associated with the student;
accepting student progress data, the student progress data comprising completed assignment data and test results in accordance with a predetermined student schedule;
generating a student progress report based on at least one of the data relating to a student record, the data relating to the predetermined set of progress goals, the data relating to a predetermined study plan, and the student progress data;
modifying at least one of the data relating to a student record, the data relating to the predetermined set of progress goals, and the data relating to a predetermined study plan; and
storing the data relating to a student record, the data relating to a predetermined set of progress goals, the data relating to a predetermined study plan, and the student progress data, all in the computer database.

22. The method of claim 21 further comprising:
providing an instructor alerts database, the instructor alerts database comprising a plurality of instructor alert conditions;
automatically generating an instructor alert report for a student whose progress data indicates that the student's performance matches one or more of the instructor alert conditions contained in the instructor alerts database;
modifying at least one of the data relating to a student record, the data relating to the predetermined set of progress goals, the data relating to a predetermined study plan, and the student progress data;
automatically updating the data relating to the student record, the data relating to the predetermined set of progress goals, and the data relating to a predetermined study plan; and
storing in the computer database the updated data relating to the student record, the updated data relating to the predetermined set of progress goals, the updated data relating to a predetermined study plan, and the updated student progress data.

23. An automated education management system, the system comprising:
an menu module, that presents a plurality of menus to an instructor on a computer terminal, the plurality of menus comprising a student record menu, a study plan menu, a progress goals menu, and a progress report menu;
a data entry module that permits the instructor using an input device to enter diagnostic test data and student progress data for a plurality of students, the student progress data comprising completed assignment data and test results in accordance with a student schedule for each of the plurality of students;
a storage module that stores, at least, the diagnostic test data and the student progress data so that one or more of the diagnostic test data and the student progress data can be presented when one or more of the plurality of menus is accessed by the instructor;
one or more template modules, associated with the plurality of menus, the one or more template modules comprising at least one of a student record template module, a set of progress goals template module, a study plan template module, and a progress report template module;
a selection module for enabling an instructor to select one or more menus and one or more modules using an input device; and
an assembly module that assembles a student record comprising a set of progress goals, a study plan, and a progress report using the one or more template modules and the one or more of the plurality of menus, the set of progress goals comprising one or more study levels, a plurality of assignments for each of the one or more study levels, and an estimated timeframe for completing the plurality of assignments for each of the one or more study levels, the study plan comprising a student schedule, and the progress report comprising the student progress data and any deviations from the study plan.

24. The system of claim 23 wherein:
the automated education system exists as a computer program on a computer readable medium.

25. The system of claim 23 further comprising:
an instructor preparation module for determining which students are scheduled to attend a particular class session, what consumable educational materials are required for the particular class session, and which if any students do not have predetermined assignments for the particular class session.

26. The system of claim 23 further comprising:
a progress monitoring module that automatically compares the progress report with a predetermined set of instructor alert conditions and automatically generates an instructor alert report for a student whose progress data indicates that the student's performance matches one or more of the instructor alert conditions, indicating the student's performance has dropped below a predetermined threshold; and
an alert presentation module that automatically displays an instructor alert report to the instructor on the computer terminal.

27. The system of claim 23 wherein:
the one or more template modules further comprises a repetition plan template module, the repetition plan template module comprising a predetermined repetition plan for repeating at least a portion of the plurality of assignments for one or more study levels; and
the assembly module assembles the student record comprising a set of progress goals, a study plan, and a progress report using the repetition plan template module and the one or more of the plurality of menus.

28. The system of claim 23 further comprising:
a batch assembly module that automatically assembles the student record comprising a set of progress goals, a study plan, and a progress report for each of a plurality of students using the one or more template modules and the one or more of the plurality of menus.

29. The system of claim 23 further comprising:
a template creation module that stores at least one of a student record to a student record template module, an instructor created set of progress goals to a set of progress goals template module, an instructor created study plan to a study plan template module, and an instructor created progress report to a progress report template module.

30. The system of claim 23 further comprising:
an inventory prediction module for estimating a quantity of consumable educational materials to be used in a predetermined time period, said quantity of consumable educational materials being estimated using at least one of (1) a quantity of consumable educational materials used in a preceding time period and (2) a quantity of consumable educational materials projected for the predetermined time period based on the study plan for each of a plurality of students; and
an inventory management module for tracking the use of consumable educational materials and generating an order for additional consumable educational materials based on the estimated quantity of educational materials to be used in a predetermined time period.

31. The system of claim 23 further comprising:
a financial management module for generating tuition bills based on student data stored in the storage module and tracking tuition payments.

32. The system of claim 31 wherein:
the financial management module (1) compares a quantity of consumable educational materials used in a preceding time period with an expected quantity of consumable educational materials used based on the student progress data stored in the storage module and (2) generates a disparity report if the difference between the quantity used and the expected quantity used exceeds a predetermined threshold.

33. A computer program embodied in a computer readable medium for automating an education system, the program comprising:
an menu module, that presents a plurality of menus to an instructor on a computer terminal, the plurality of menus comprising a student record menu, a study plan menu, a progress goals menu, and a progress report menu;
a data entry module that permits the instructor using an input device to enter diagnostic test data and student progress data for a plurality of students, the student progress data comprising completed assignment data and test results in accordance with a student schedule for each of the plurality of students;
a storage module that stores, at least, the diagnostic test data and the student progress data so that one or more of the diagnostic test data and the student progress data can be presented when one or more of the plurality of menus is accessed by the instructor;
one or more template modules, associated with the plurality of menus, the one or more template modules comprising at least one of a student record template module, a set of progress goals template module, a study plan template module, and a progress report template module;
a selection module for enabling an instructor to select one or more menus and one or more modules using an input device; and
an assembly module that assembles a student record comprising a set of progress goals, a study plan, and a progress report using the one or more template modules and the one or more of the plurality of menus, the set of progress goals comprising one or more study levels, a plurality of assignments for each of the one or more study levels, and an estimated timeframe for completing the plurality of assignments for each of the one or more study levels, the study plan comprising a student schedule, and the progress report comprising the student progress data and any deviations from the study plan.

34. The program of claim 33 further comprising:
an instructor preparation module for determining which students are scheduled to attend a particular class session, what consumable educational materials are required for the particular class session, and which if any students do not have predetermined assignments for the particular class session.

35. The program of claim 33 further comprising:
a progress monitoring module that automatically compares the progress report with a predetermined set of instructor alert conditions and automatically generates an instructor alert report for a student whose progress data indicates that the student's performance matches one or more of the instructor alert conditions, indicating the student's performance has dropped below a predetermined threshold; and
an alert presentation module that automatically displays an instructor alert report to the instructor on the computer terminal.

36. The program of claim 33 wherein:
the one or more template modules further comprises a repetition plan template module, the repetition plan template module comprising a predetermined repetition plan for repeating at least a portion of the plurality of assignments for one or more study levels; and
the assembly module assembles the student record comprising a set of progress goals, a study plan, and a progress report using the repetition plan template module and the one or more of the plurality of menus.

37. The program of claim 33 further comprising:
a batch assembly module that automatically assembles the student record comprising a set of progress goals, a study plan, and a progress report for each of a plurality of students using the one or more template modules and the one or more of the plurality of menus.

38. The program of claim 33 further comprising:
a template creation module that stores at least one of a student record to a student record template module, an instructor created set of progress goals to a set of progress goals template module, an instructor created study plan to a study plan template module, and an instructor created progress report to a progress report template module.

39. The program of claim 33 further comprising:
an inventory prediction module for estimating a quantity of consumable educational materials to be used in a predetermined time period, said quantity of consumable educational materials being estimated using at least one of (1) a quantity of consumable educational materials used in a preceding time period and (2) a quantity of consumable educational materials projected for the predetermined time period based on the study plan for each of a plurality of students; and
an inventory management module for tracking the use of consumable educational materials and generating an order for additional consumable educational materials based on the estimated quantity of educational materials to be used in a predetermined time period.

40. The program of claim 33 further comprising:
a financial management module for generating tuition bills based on student data stored in the storage module and tracking tuition payments.

41. The program of claim 40 wherein:
the financial management module (1) compares a quantity of consumable educational materials used in a preceding time period with an expected quantity of consumable educational materials used based on the student progress data stored in the storage module and (2) generates a disparity report if the difference between the quantity used and the expected quantity used exceeds a predetermined threshold.
